(19) United States
(12) Patent Application Publication
(10) Pub. No.: US 2024/0204554 A1
(43) Pub. Date: Jun. 20, 2024

(54) SWITCHED-MODE POWER SUPPLY CHARGERS WITH FAULT DETECTION RELATED TO LIMITED POWER SOURCE PROTECTION

(71) Applicant: ON-BRIGHT ELECTRONICS (SHANGHAI) CO., LTD., Shanghai (CN)

(72) Inventors: ZHIQIANG WANG, Shanghai (CN); WEI HUANG, Shanghai (CN); YUNCHAO ZHANG, Shanghai (CN)

(21) Appl. No.: 18/544,804

(22) Filed: Dec. 19, 2023

(30) Foreign Application Priority Data
Dec. 19, 2022 (CN) 202211630534.3

(51) Int. Cl. H02J 7/00; H02M 1/00; H02M 1/092; H02M 3/335

(52) U.S. Cl. CPC H02J 7/007182; H02M 1/0022; H02M 1/092; H02M 3/33515; H02J 2207/20

(57) ABSTRACT

Fast charging protocol controller and method thereof. For example, a fast charging protocol controller for a power supply charger includes: a first transistor voltage-drop detector configured to detect a first transistor voltage drop from a first drain of a first transistor to a first source of the first transistor, the first transistor being configured to provide an output current of the power supply charger and an output voltage of the power supply charger; a resistor voltage-drop detector configured to detect a resistor voltage drop from a first resistor terminal of a first resistor to a second resistor terminal of the first resistor, the first resistor being configured to receive a resistor current that is equal to the output current in magnitude; and a logic controller coupled to the first transistor voltage-drop detector and the resistor voltage-drop detector.

### 1. CROSS-REFERENCES TO RELATED APPLICATIONS

This application claims priority to Chinese Patent Application No. 202211630534.3, filed on Dec. 19, 2022, incorporated by reference herein for all purposes.

### 2. FIELD OF THE DISCLOSURE

Certain embodiments of the present disclosure are directed to circuits. More particularly, some embodiments of the disclosure provide switched-mode power supply chargers with fault detection. Merely by way of example, some embodiments of the disclosure have been applied to limited power source protection. But it would be recognized that the disclosure has a much broader range of applicability.

### 3. BACKGROUND OF THE DISCLOSURE

With the increase in battery capacity and the increase in desired charging speed, the maximum output power and the maximum output current of battery chargers for mobile electronic devices need to increase significantly. As an example, the maximum output power of conventional chargers now ranges from 80 watts to 90 watts, and their maximum output current is about 7.5 amps. Additionally, these conventional chargers also often need to satisfy the requirements of limited power source (LPS). For example, according to the requirements of limited power source (LPS), the output power of the chargers should be less than 100 watts, and their output current should be less than 8 amps.

FIG. 1 is a simplified diagram showing a conventional switched-mode power supply charger. The switched-mode power supply charger 100 includes a pulse-width-modulation controller 110, a primary winding 112, a secondary winding 114, a fast charging protocol chip 120, a resistor 130, a transistor 140, and a USB Type-C output port 150. For example, the resistor 130 has high-precision resistance (e.g., 5 mΩ) with small temperature coefficient of resistance. As an example, the transistor 140 is a metal-oxide-semiconductor field-effect transistor (MOSFET). For example, the primary winding 112 and the secondary winding 114 are coupled to each other. In some examples, if the maximum output power of the switched-mode power supply charger 100 is 65 watts and the maximum output current of the switched-mode power supply charger 100 is 3.25 amps, the switched-mode power supply charger 100 uses the pulse-width-modulation controller 110 to limit the output power and the output current in order to achieve the limited power source (LPS) protection. For example, the maximum output power of 65 watts is significantly lower than the maximum output power of 100 watts that is required for the limited power source (LPS) protection, so the limited accuracy of the pulse-width-modulation controller 110 in controlling the output current and/or the output power is still sufficient for the limited power source (LPS) protection.

In certain examples, if the maximum output power of the switched-mode power supply charger 100 ranges from 80 watts to 90 watts and the maximum output current of the switched-mode power supply charger 100 is 8 amps, the switched-mode power supply charger 100 uses the fast charging protocol chip 120 to limit the output power and the output current in order to achieve the limited power source (LPS) protection. For example, the fast charging protocol chip 120 detects a voltage across the resistor 130 to accurately determine the actual output current and the actual output power of the switched-mode power supply charger 100. As an example, if the fast charging protocol chip 120 determines that the actual output current exceeds a predetermined current threshold for the limited power source (LPS) protection and/or the actual output power exceeds a predetermined power threshold for the limited power source (LPS) protection, the fast charging protocol chip 120 outputs a control signal 141 to turn off the transistor 140 in order to achieve the limited power source (LPS) protection.

Hence it is highly desirable to improve the technique for the limited power source (LPS) protection related to switched-mode power supply chargers.

### 4. BRIEF SUMMARY OF THE DISCLOSURE

Certain embodiments of the present disclosure are directed to circuits. More particularly, some embodiments of the disclosure provide switched-mode power supply chargers with fault detection. Merely by way of example, some embodiments of the disclosure have been applied to limited power source protection. But it would be recognized that the disclosure has a much broader range of applicability.

According to certain embodiments, a fast charging protocol controller for a power supply charger includes: a first transistor voltage-drop detector configured to detect a first transistor voltage drop from a first drain of a first transistor to a first source of the first transistor, the first transistor being configured to provide an output current of the power supply charger and an output voltage of the power supply charger; a resistor voltage-drop detector configured to detect a resistor voltage drop from a first resistor terminal of a first resistor to a second resistor terminal of the first resistor, the first resistor being configured to receive a resistor current that is equal to the output current in magnitude; and a logic controller coupled to the first transistor voltage-drop detector and the resistor voltage-drop detector; wherein the first transistor voltage-drop detector is further configured to: compare the detected first transistor voltage drop with a first threshold voltage to generate a first comparison signal; and compare the detected first transistor voltage drop with a second threshold voltage to generate a second comparison signal; wherein the resistor voltage-drop detector is further configured to: compare the detected resistor voltage drop with a third threshold voltage to generate a third comparison signal; and compare the detected resistor voltage drop with a fourth threshold voltage to generate a fourth comparison signal; the logic controller is further configured to: receive the first comparison signal and the second comparison signal from the first transistor voltage-drop detector; receive the third comparison signal and the fourth comparison signal from the resistor voltage-drop detector; determine, based at least in part on the first comparison signal, the second comparison signal, the third comparison signal and the fourth comparison signal, whether or not a first fault related to the first transistor exists and whether or not a second fault related to the first resistor exists; and output, based at least in part on whether or not the first fault exists and whether or not the second fault exists, at least one or more control signals related to a limited power source protection for the power supply charger.

According to some embodiments, a power supply charger includes: a first transistor configured to provide an output current of the power supply charger and an output voltage of the power supply charger; a first resistor configured to receive a resistor current that is equal to the output current in magnitude; and a fast charging protocol controller coupled to the first transistor and the first resistor; wherein the fast charging protocol controller includes: a first transistor voltage-drop detector configured to detect a first transistor voltage drop from a first drain of the first transistor to a first source of the first transistor; a resistor voltage-drop detector configured to detect a resistor voltage drop from a first resistor terminal of the first resistor to a second resistor terminal of the first resistor; and a logic controller coupled to the first transistor voltage-drop detector and the resistor voltage-drop detector; wherein the first transistor voltage-drop detector is further configured to: compare the detected first transistor voltage drop with a first threshold voltage to generate a first comparison signal; and compare the detected first transistor voltage drop with a second threshold voltage to generate a second comparison signal; wherein the resistor voltage-drop detector is further configured to: compare the detected resistor voltage drop with a third threshold voltage to generate a third comparison signal; and compare the detected resistor voltage drop with a fourth threshold voltage to generate a fourth comparison signal; the logic controller is further configured to: receive the first comparison signal and the second comparison signal from the first transistor voltage-drop detector; receive the third comparison signal and the fourth comparison signal from the resistor voltage-drop detector; determine, based at least in part on the first comparison signal, the second comparison signal, the third comparison signal and the fourth comparison signal, whether or not a first fault related to the first transistor exists and whether or not a second fault related to the first resistor exists; and output, based at least in part on whether or not the first fault exists and whether or not the second fault exists, at least one or more control signals related to a limited power source protection for the power supply charger.

According to certain embodiments, a method for a fast charging protocol controller of a power supply charger includes: detecting a first transistor voltage drop from a first drain of a first transistor to a first source of the first transistor to generate a first comparison signal and a second comparison signal, the first transistor being configured to provide an output current of the power supply charger and an output voltage of the power supply charger; detecting a resistor voltage drop from a first resistor terminal of a first resistor to a second resistor terminal of the first resistor to generate a third comparison signal and a fourth comparison signal, the first resistor being configured to receive a resistor current that is equal to the output current in magnitude; and outputting at least one or more control signals related to a limited power source protection for the power supply charger based at least in part on the first comparison signal, the second comparison signal, the third comparison signal, and the fourth comparison signal; wherein the detecting a first transistor voltage drop from a first drain of a first transistor to a first source of the first transistor to generate a first comparison signal and a second comparison signal includes: comparing the detected first transistor voltage drop with a first threshold voltage to generate the first comparison signal; and comparing the detected first transistor voltage drop with a second threshold voltage to generate the second comparison signal; wherein the detecting a resistor voltage drop from a first resistor terminal of a first resistor to a second resistor terminal of the first resistor to generate a third comparison signal and a fourth comparison signal includes: comparing the detected resistor voltage drop with a third threshold voltage to generate the third comparison signal; and comparing the detected resistor voltage drop with a fourth threshold voltage to generate the fourth comparison signal; wherein the outputting at least one or more control signals related to a limited power source protection for the power supply charger includes; receiving the first comparison signal, the second comparison signal, the third comparison signal and the fourth comparison signal; determining, based at least in part on the first comparison signal, the second comparison signal, the third comparison signal and the fourth comparison signal, whether or not a first fault related to the first transistor exists and whether or not a second fault related to the first resistor exists; and outputting, based at least in part on whether or not the first fault exists and whether or not the second fault exists, at least the one or more control signals related to the limited power source protection for the power supply charger.

Depending upon embodiment, one or more benefits may be achieved. These benefits and various additional objects, features and advantages of the present disclosure can be fully appreciated with reference to the detailed description and accompanying drawings that follow:

### 5. BRIEF DESCRIPTION OF THE DRAWINGS

FIG. 1 is a simplified diagram showing a conventional switched-mode power supply charger.

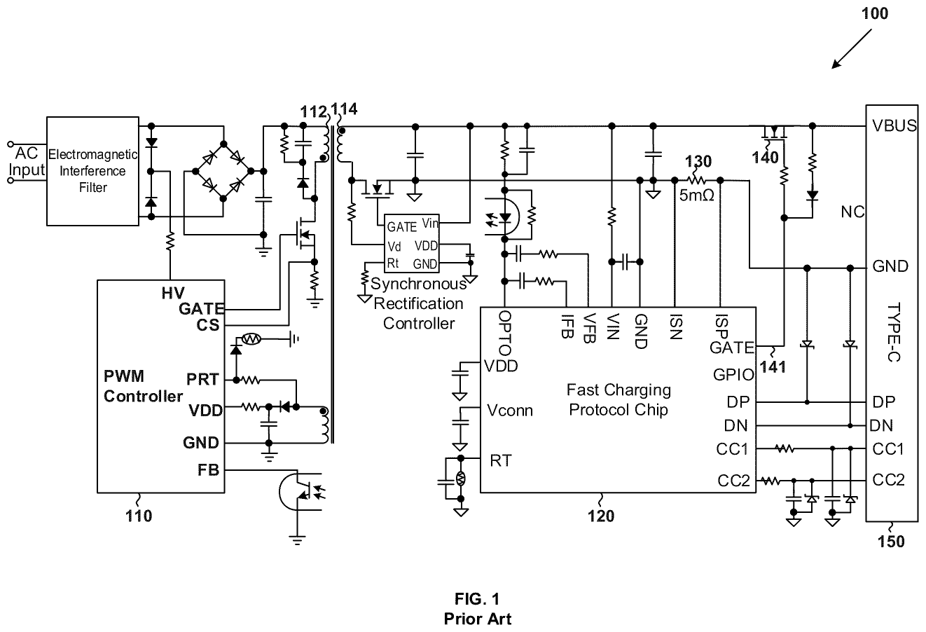

FIG. 2 is a simplified diagram showing a switched-mode power supply charger according to certain embodiments of the present disclosure.

FIG. 3 is a simplified diagram showing certain components of the switched-mode power supply charger as shown in FIG. 2 according to some embodiments of the present disclosure.

FIG. 4 is a simplified diagram showing certain components of the fast charging protocol chip as part of the switched-mode power supply charger as shown in FIG. 2 and FIG. 3 according to certain embodiments of the present disclosure.

FIG. 5 is a simplified diagram showing the switched-mode power supply charger as shown in FIG. 2, FIG. 3 and FIG. 4 that is connected to a load according to some embodiments of the present disclosure.

FIG. 6 is a simplified diagram showing certain components of a switched-mode power supply charger according to certain embodiments of the present disclosure.

FIG. 7 is a simplified diagram showing the transistor combination of the switched-mode power supply charger as shown in FIG. 6 according to some embodiments of the present disclosure.

### 6. DETAILED DESCRIPTION OF THE DISCLOSURE

Certain embodiments of the present disclosure are directed to circuits. More particularly, some embodiments of the disclosure provide switched-mode power supply chargers with fault detection. Merely by way of example, some embodiments of the disclosure have been applied to limited power source protection. But it would be recognized that the disclosure has a much broader range of applicability.

According to some embodiments, to achieve the limited power source (LPS) protection for the switched-mode power supply charger 100, the fast charging protocol chip 120 detects a voltage across the resistor 130 in order to determine whether or not the actual output current of the switched-mode power supply charger 100 exceeds the predetermined current threshold for the limited power source (LPS) protection and/or whether or not the actual output power of the switched-mode power supply charger 100 exceeds the predetermined power threshold for the limited power source (LPS) protection according to some embodiments. For example, if there is a short circuit in the resistor 130, the fast charging protocol chip 120 cannot accurately determine the actual output current and the actual output power of the switched-mode power supply charger 100, so the switched-mode power supply charger 100 cannot achieve the limited power source (LPS) protection.

According to certain embodiments, if the fast charging protocol chip 120 determines that the actual output current exceeds the predetermined current threshold for the limited power source (LPS) protection and/or the actual output power exceeds the predetermined power threshold for the limited power source (LPS) protection, the fast charging protocol chip 120 outputs the control signal 141 to turn off the transistor 140 in order to achieve the limited power source (LPS) protection. For example, if there is a short circuit between the source and the drain of the transistor 140, the control signal 141 cannot turn off the transistor 140, so the switched-mode power supply charger 100 cannot achieve the limited power source (LPS) protection.

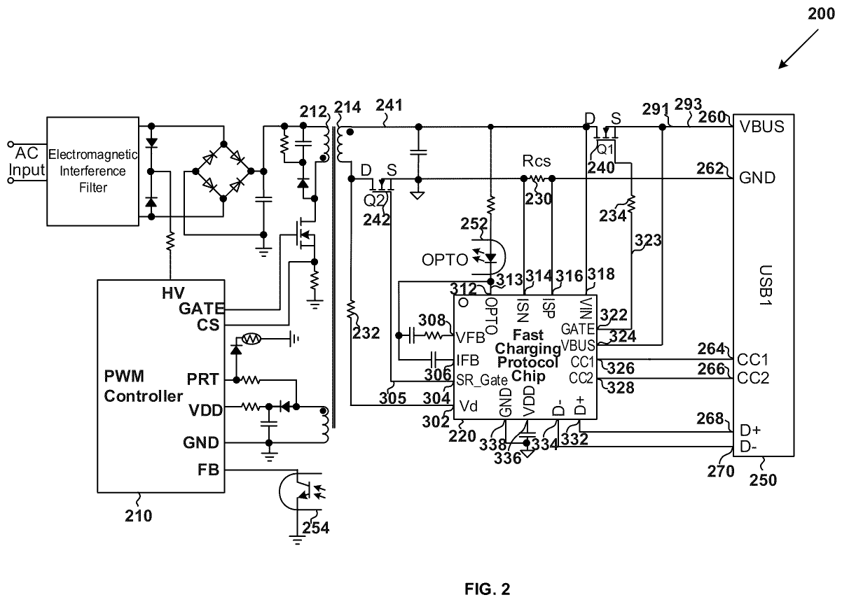

FIG. 2 is a simplified diagram showing a switched-mode power supply charger according to certain embodiments of the present disclosure. This diagram is merely an example, which should not unduly limit the scope of the claims. One of ordinary skill in the art would recognize many variations, alternatives, and modifications. The switched-mode power supply charger 200 includes a pulse-width-modulation controller 210, a primary winding 212, a secondary winding 214, a fast charging protocol chip 220, resistors 230, 232 and 234, transistors 240 and 242, and a USB Type-C output port 250, an optocoupler emitter 252, and an optocoupler receiver 254. For example, the resistor 230 has high-precision resistance (e.g., 5 mΩ) with small temperature coefficient of resistance. As an example, each transistor of the transistors 240 and 242 is a metal-oxide-semiconductor field-effect transistor (MOSFET). For example, the optocoupler emitter 252 and the optocoupler receiver 254 are parts of an optocoupler. As an example, the primary winding 212 and the secondary winding 214 are coupled to each other. Although the above has been shown using a selected group of components for the switched-mode power supply charger, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

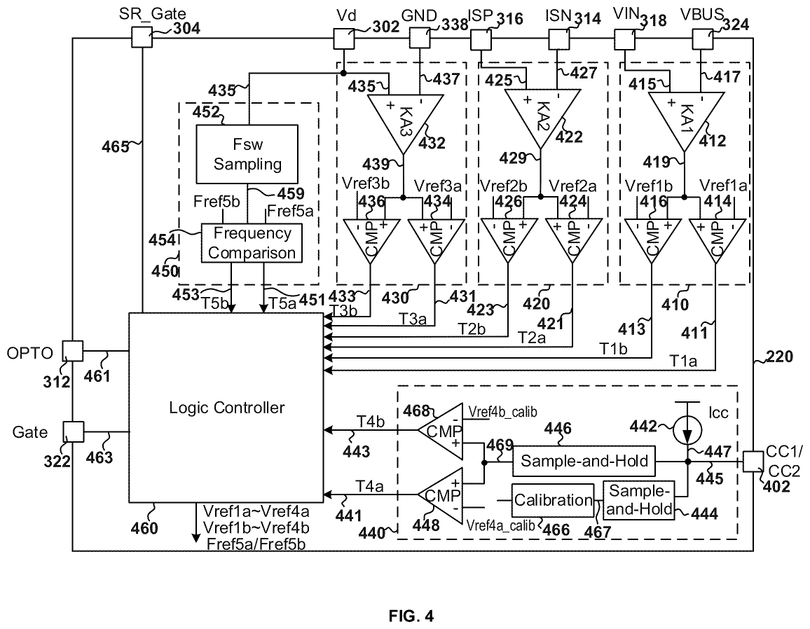

In some embodiments, the switched-mode power supply charger 200 is configured to achieve the limited power source (LPS) protection even if one or more faults related to the limited power source (LPS) protection exist in the switched-mode power supply charger 200. In certain embodiments, the switched-mode power supply charger 200 includes the fast charging protocol chip 220 (e.g., a fast charging protocol controller) as shown in FIG. 4. For example, the fast charging protocol chip 220 (e.g., a fast charging protocol controller) is coupled to the transistor 240, the resistor 230, and the transistor 242.

According to some embodiments, the fast charging protocol chip 220 includes terminals (e.g., pins) 302, 304, 306, 308, 312, 314, 316, 318, 322, 324, 326, 328, 332, 334, 336, and 338 according to some embodiments. In certain examples, the terminal 304 (e.g., a pin) is connected to the gate of the transistor 242. For example, the terminal 304 (e.g., a pin) outputs a signal 305. In some examples, the terminal 302 (e.g., a pin) is connected to the drain of the transistor 242 through the resistor 232. For example, the drain of the transistor 242 is connected to the secondary winding 214. In certain examples, the terminal 338 (e.g., a pin) is biased to a ground voltage, to which the source of the transistor 242 is also biased. In some examples, the terminal 316 (e.g., a pin) is connected to one terminal of the resistor 230, and the terminal 314 (e.g., a pin) is connected to another terminal of the resistor 230. In certain examples, the terminal 318 (e.g., a pin) is connected to the drain of the transistor 240. For example, the drain of the transistor 240 is biased to a voltage 241. In some examples, the terminal 324 (e.g., a pin) is connected to the source of the transistor 240. In certain examples, the terminal 312 (e.g., a pin) is connected to the optocoupler emitter 252. For example, the terminal 312 (e.g., a pin) outputs a signal 313. In some examples, the terminal 322 (e.g., a pin) is connected to the gate of the transistor 240 through the resistor 234. For example, the terminal 322 (e.g., a pin) outputs a signal 323.

According to certain embodiments, the USB Type-C output port 250 includes pins 260, 262, 264, 266, 268 and 270. For example, the pin 260 is connected to the terminal 324 (e.g., a pin). As an example, the pin 262 is biased to the ground voltage, to which the terminal 338 (e.g., a pin) is also biased. For example, the pin 264 is connected to the terminal 326 (e.g., a pin). As an example, the pin 266 is connected to the terminal 328 (e.g., a pin). For example, the pin 268 is connected to the terminal 332 (e.g., a pin). As an example, the pin 270 is connected to the terminal 334 (e.g., a pin). In some examples, the transistor 240 provides a voltage 291 and a current 293, which are received by the pin 260. For example, the voltage 291 is equal to the voltage at the source of the transistor 240. As an example, the current 293 is equal to the current that flows from the drain of the transistor 240 to the source of the transistor 240 when the transistor 240 is turned on. For example, the current 293 is equal to the current that is received by the resistor 230, and the current 293 is equal to the current that flows through the resistor 230. As an example, the current 293 is equal to the current that flows from the drain of the transistor 242 to the source of the transistor 242 when the transistor 242 is turned on. In certain examples, the voltage 291 is used as an output voltage of the switched-mode power supply charger 200, and the current 293 is used as an output current of the switched-mode power supply charger 200. For example, the output power of the switched-mode power supply charger 200 is equal to the voltage 291 multiplied by the current 293.

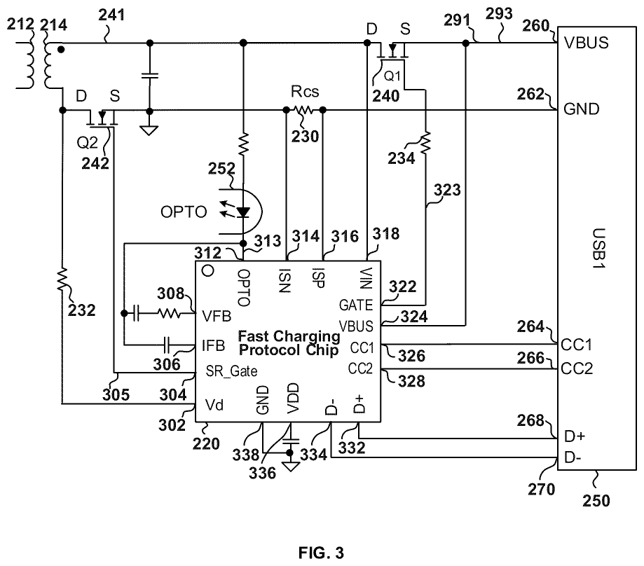

FIG. 3 is a simplified diagram showing certain components of the switched-mode power supply charger 200 as shown in FIG. 2 according to some embodiments of the present disclosure. This diagram is merely an example, which should not unduly limit the scope of the claims. One of ordinary skill in the art would recognize many variations, alternatives, and modifications. The switched-mode power supply charger 200 includes the fast charging protocol chip 220, the primary winding 212, the secondary winding 214, the resistors 230, 232 and 234, the transistors 240 and 242, the USB Type-C output port 250, and the optocoupler emitter 252, and the fast charging protocol chip 220. For example, the USB Type-C output port 250 includes the pins 260, 262, 264, 266, 268 and 270. As an example, the fast charging protocol chip 220 includes the terminals (e.g., pins) 302, 304, 306, 308, 312, 314, 316, 318, 322, 324, 326, 328, 332, 334, 336, and 338. Although the above has been shown using a selected group of components for the switched-mode power supply charger, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some embodiments, the switched-mode power supply charger 200 is configured to achieve the limited power source (LPS) protection even if one or more faults related to the limited power source (LPS) protection exist in the switched-mode power supply charger 200. In certain embodiments, the switched-mode power supply charger 200 includes the fast charging protocol chip 220 as shown in FIG. 4. For example, the fast charging protocol chip 220 includes a circuit for detecting one or more faults related to the limited power source (LPS) protection.

FIG. 4 is a simplified diagram showing certain components of the fast charging protocol chip 220 as part of the switched-mode power supply charger 200 as shown in FIG. 2 and FIG. 3 according to certain embodiments of the present disclosure. This diagram is merely an example, which should not unduly limit the scope of the claims. One of ordinary skill in the art would recognize many variations, alternatives, and modifications. The fast charging protocol chip 220 includes an output transistor voltage-drop detector 410, a resistor voltage-drop detector 420, a synchronous rectification voltage-drop detector 430, a fast charging protocol communication detector 440, a switching frequency detector 450, and a logic controller 460. As an example, the logic controller 460 are coupled to the output transistor voltage-drop detector 410, the resistor voltage-drop detector 420, the synchronous rectification voltage-drop detector 430, the fast charging protocol communication detector 440, and the switching frequency detector 450. Although the above has been shown using a selected group of components for the fast charging protocol chip, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some examples, the output transistor voltage-drop detector 410 is connected to the terminals 318 and 324. In certain examples, the resistor voltage-drop detector 420 is connected to the terminals 314 and 316. In some examples, the synchronous rectification voltage-drop detector 430 is connected to the terminals 302 and 338. In certain examples, the fast charging protocol communication detector 440 is connected to a terminal 402, which is either the terminal 326 or the terminal 328. For example, the fast charging protocol communication detector 440 is connected to the terminal 326 (e.g., a pin), which is connected to the pin 264. As an example, the fast charging protocol communication detector 440 is connected to the terminal 328 (e.g., a pin), which is connected to the pin 266. In some examples, the switching frequency detector 450 is connected to the terminal 302. In certain examples, the logic controller 460 is connected to the terminals 312 and 322.

According to some embodiments, the output transistor voltage-drop detector 410 is connected to the terminals 318 and 324. For example, the terminal 318 (e.g., a pin) is connected to the drain of the transistor 240. As an example, the terminal 324 (e.g., a pin) is connected to the source of the transistor 240. In certain examples, the output transistor voltage-drop detector 410 detects the voltage drop from the drain of the transistor 240 to the source of the transistor 240 when the transistor 240 is turned on. For example, the output transistor voltage-drop detector 410 also compares the detected voltage drop from the drain to the source of the transistor 240 when the transistor 240 is turned on with a threshold voltage V_{ref1a} and in response generates a comparison signal 411 (e.g., T₁ₐ). As an example, the output transistor voltage-drop detector 410 also compares the detected voltage drop from the drain to the source of the transistor 240 when the transistor 240 is turned on with a threshold voltage V_{ref1b} and in response generates a comparison signal 413 (e.g., T_{1b}). In some examples, the comparison signals 411 and 413 are received by the logic controller 460. For example, if the detected voltage drop from the drain to the source of the transistor 240 when the transistor 240 is turned on is larger than the threshold voltage V_{ref1a}, the comparison signal 411 is at a logic high level, and if the detected voltage drop from the drain to the source of the transistor 240 when the transistor 240 is turned on is smaller than or equal to the threshold voltage V_{ref1a}, the comparison signal 411 is at a logic low level. As an example, if the detected voltage drop from the drain to the source of the transistor 240 when the transistor 240 is turned on is larger than the threshold voltage V_{ref1b}, the comparison signal 413 is at a logic high level, and if the detected voltage drop from the drain to the source of the transistor 240 when the transistor 240 is turned on is smaller than or equal to the threshold voltage V_{ref1b}, the comparison signal 413 is at a logic low level.

According to certain embodiments, the resistor voltage-drop detector 420 is connected to the terminals 314 and 316. For example, the terminal 316 (e.g., a pin) is connected to one terminal of the resistor 230. As an example, the terminal 314 (e.g., a pin) is connected to another terminal of the resistor 230. In some examples, the resistor voltage-drop detector 420 detects the voltage drop from the one terminal of the resistor 230 to the another terminal of the resistor 230. For example, the resistor voltage-drop detector 420 also compares the voltage drop from the one terminal to the another terminal of the resistor 230 with a threshold voltage V_{ref2a} and in response generates a comparison signal 421 (e.g., T₂ₐ). As an example, the resistor voltage-drop detector 420 also compares the voltage drop from the one terminal to the another terminal of the resistor 230 with a threshold voltage V_{ref2b} and in response generates a comparison signal 423 (e.g., T_{2b}). In some examples, the comparison signals 421 and 423 are received by the logic controller 460. For example, if the detected voltage drop from the one terminal to the another terminal of the resistor 230 is larger than the threshold voltage V_{ref2a}, the comparison signal 421 is at a logic high level, and if the detected voltage drop from the one terminal to the another terminal of the resistor 230 is smaller than or equal to the threshold voltage V_{ref2a}, the comparison signal 421 is at a logic low level. As an example, if the detected voltage drop from the one terminal to the another terminal of the resistor 230 is larger than the threshold voltage V_{ref2b}, the comparison signal 423 is at a logic high level, and if the detected voltage drop from the one terminal to the another terminal of the resistor 230 is smaller than or equal to the threshold voltage V_{ref2b}, the comparison signal 423 is at a logic low level.

According to some embodiments, the synchronous rectification voltage-drop detector 430 is connected to the terminals 302 and 338. For example, the terminal 302 (e.g., a pin) is connected to the drain of the transistor 242 through the resistor 232. As an example, the terminal 338 (e.g., a pin) is biased to a ground voltage, to which the source of the transistor 242 is also biased. In certain examples, the synchronous rectification voltage-drop detector 430 detects the voltage drop from the drain of the transistor 242 to the source of the transistor 242 when the transistor 242 is turned on. For example, the synchronous rectification voltage-drop detector 430 also compares the detected voltage drop from the drain to the source of the transistor 242 when the transistor 242 is turned on with a threshold voltage V_{ref3a} and in response generates a comparison signal 431 (e.g., T₃ₐ). As an example, the synchronous rectification voltage-drop detector 430 also compares the detected voltage drop from the drain to the source of the transistor 242 when the transistor 242 is turned on with a threshold voltage V_{ref5b} and in response generates a comparison signal 433 (e.g., T_{3b}). In some examples, the comparison signals 431 and 433 are received by the logic controller 460. For example, if the detected voltage drop from the drain to the source of the transistor 242 when the transistor 242 is turned on is larger than the threshold voltage V_{ref3a}, the comparison signal 431 is at a logic high level, and if the detected voltage drop from the drain to the source of the transistor 242 when the transistor 242 is turned on is smaller than or equal to the threshold voltage V_{ref3a}, the comparison signal 431 is at a logic low level. As an example, if the detected voltage drop from the drain to the source of the transistor 242 when the transistor 242 is turned on is larger than the threshold voltage V_{ref3b}, the comparison signal 433 is at a logic high level, and if the detected voltage drop from the drain to the source of the transistor 242 when the transistor 242 is turned on is smaller than or equal to the threshold voltage V_{ref3b}, the comparison signal 433 is at a logic low level.

According to certain embodiments, the fast charging protocol communication detector 440 is connected to the terminal 402, which is either the terminal 326 or the terminal 328. For example, the terminal 326 is connected to the pin 264. As an example, the terminal 328 is connected to the pin 266. In some examples, the fast charging protocol communication detector 440 (e.g., a voltage detector) detects a voltage 445 (e.g., an input voltage) of the terminal 402 (e.g., the terminal 326 or the terminal 328) when the transistor 240 is turned on and the USB Type-C output port 250 is connected to a load (e.g., a mobile electronic device). For example, the fast charging protocol communication detector 440 also compares the detected voltage 445 when the transistor 240 is turned on and the USB Type-C output port 250 is connected to a load with a calibrated threshold voltage V_{ref4a_calib} and in response generates a comparison signal 441 (e.g., T₄ₐ). As an example, the fast charging protocol communication detector 440 also compares the detected voltage 445 when the transistor 240 is turned on and the USB Type-C output port 250 is connected to a load with a calibrated threshold voltage V_{ref4b_calib} and in response generates a comparison signal 443 (e.g., T_{4b}). In some examples, the comparison signals 441 and 443 are received by the logic controller 460. For example, if the detected voltage 445 when the transistor 240 is turned on and the USB Type-C output port 250 is connected to a load is larger than the calibrated threshold voltage V_{ref4a_calib}, the comparison signal 441 is at a logic high level, and if the detected voltage 445 when the transistor 240 is turned on and the USB Type-C output port 250 is connected to a load is smaller than or equal to the calibrated threshold voltage V_{ref4a_calib}, the comparison signal 441 is at a logic low level. As an example, if the detected voltage 445 when the transistor 240 is turned on and the USB Type-C output port 250 is connected to a load is larger than the calibrated threshold voltage V_{ref4b_calib}, the comparison signal 443 is at a logic high level, and if the detected voltage 445 when the transistor 240 is turned on and the USB Type-C output port 250 is connected to a load is smaller than or equal to the calibrated threshold voltage V_{ref4b_calib}, the comparison signal 443 is at a logic low level.

According to some embodiments, the switching frequency detector 450 is connected to the terminal 302. For example, the terminal 302 is connected to the drain of the transistor 242 through the resistor 232. In some examples, the switching frequency detector 450 detects a switching frequency of the switched-mode power supply charger 200. For example, the switching frequency detector 450 also compares the detected switching frequency with a threshold frequency F_{ref5a} and in response generates a comparison signal 451 (e.g., T₅ₐ). As an example, the switching frequency detector 450 also compares the detected switching frequency with a threshold frequency F_{ref5b} and in response generates a comparison signal 453 (e.g., T_{5b}). In some examples, the comparison signals 451 and 453 are received by the logic controller 460. For example, if the detected switching frequency is larger than the threshold frequency F_{ref5a}, the comparison signal 451 is at a logic high level, and if the detected switching frequency is smaller than or equal to the threshold voltage F_{ref5a}, the comparison signal 451 is at a logic low level. As an example, if the detected switching frequency is larger than the threshold frequency F_{ref5b}, the comparison signal 453 is at a logic high level, and if the detected switching frequency is smaller than or equal to the threshold frequency F_{ref5b}, the comparison signal 453 is at a logic low level.

As shown in FIG. 4, the logic controller 460 receives the comparison signal 411 (e.g., T₁ₐ) and the comparison signal 413 (e.g., T_{1b}) from the output transistor voltage-drop detector 410, receives the comparison signal 421 (e.g., T₂ₐ) and the comparison signal 423 (e.g., T_{2b}) from the resistor voltage-drop detector 420, receives the comparison signal 431 (e.g., T₃ₐ) and the comparison signal 433 (e.g., T_{3b}) from the synchronous rectification voltage-drop detector 430, receives the comparison signal 441 (e.g., T₄ₐ) and the comparison signal 443 (e.g., T_{4b}) from the fast charging protocol communication detector 440, and receives the comparison signal 451 (e.g., T₅ₐ) and the comparison signal 453 (e.g., T_{5b}) from the switching frequency detector 450 according to certain embodiments.

In some examples, the logic controller 460 outputs a signal 461, a signal 463, and/or a signal 465 based at least in part on the comparison signal 411 (e.g., T₁ₐ) and the comparison signal 413 (e.g., T_{1b}), the comparison signal 421 (e.g., T₂ₐ) and the comparison signal 423 (e.g., T_{2b}), the comparison signal 431 (e.g., T₃ₐ) and the comparison signal 433 (e.g., T_{3b}), the comparison signal 441 (e.g., T₄ₐ) and the comparison signal 443 (e.g., T_{4b}), and/or the comparison signal 451 (e.g., T₅ₐ) and the comparison signal 453 (e.g., T_{5b}), wherein each signal of the signal 461, the signal 463, and/or the signal 465 is a control signal that is related to the limited power source (LPS) protection for the switched-mode power supply charger 200. For example, the logic controller 460 generates the signal 461 and outputs the signal 461 to the terminal 312, which is connected to the optocoupler emitter 252. As an example, the logic controller 460 generates the signal 463 and outputs the signal 463 to the terminal 322, which is connected to the gate of the transistor 240 through the resistor 234. For example, the logic controller 460 generates the signal 465 and outputs the signal 465 to the terminal 304, which is connected to the gate of the transistor 242. In certain examples, the signal 461 is used as the signal 313, the signal 463 is used as the signal 323, and the signal 465 is used as the signal 305. For example, the signal 313 is outputted to the optocoupler emitter 252. As an example, the signal 323 is outputted to the gate of the transistor 240 through the resistor 234. For example, the signal 305 is outputted to the gate of the transistor 242.

In certain examples, based at least in part on the comparison signals 411, 413, 421, 423, 431, 433, 441, 443, 451, and 453, the logic controller 460 determines whether the limited power source (LPS) protection needs to be activated in order to reduce the output power of the switched-mode power supply charger 200 and/or the output current of the switched-mode power supply charger 200. For example, to reduce the output power of the switched-mode power supply charger 200 and/or the output current of the switched-mode power supply charger 200, the logic controller 460 uses the signal 463 to turn off the transistor 240. As an example, the logic controller 460 uses the signal 461 and/or the signal 465 to reduce the output power of the switched-mode power supply charger 200 and/or the output current of the switched-mode power supply charger 200.

In some embodiments, the threshold voltage V_{ref1a} is larger than the threshold voltage V_{ref1b}, the threshold voltage V_{ref2a} is larger than the threshold voltage V_{ref2b}, the threshold voltage V_{ref3a} is larger than the threshold voltage V_{ref3b}, the calibrated threshold voltage V_{ref4a_calib} is larger than the calibrated threshold voltage V_{ref4b_calib}, and the threshold frequency F_{ref5a} is larger than the threshold frequency F_{ref5b}. For example, the threshold voltage V_{ref1a} corresponds to a threshold current Iₒ₁ related to the limited power source (LPS) protection, the threshold voltage V_{ref2a} also corresponds to the threshold current Iₒ₁ related to the limited power source (LPS) protection, the threshold voltage V_{ref3a} also corresponds to the threshold current Iₒ₁ related to the limited power source (LPS) protection, the calibrated threshold voltage V_{ref4a_calib} also corresponds to the threshold current Iₒ₁ related to the limited power source (LPS) protection, and the threshold frequency F_{ref5a} also corresponds to the threshold current Iₒ₁ related to the limited power source (LPS) protection. As an example, the threshold voltage V_{ref1b} corresponds to another threshold current Iₒ₂ related to the limited power source (LPS) protection, the threshold voltage V_{ref2b} also corresponds to the threshold current Iₒ₂ related to the limited power source (LPS) protection, the threshold voltage V_{ref3b} also corresponds to the threshold current Iₒ₂ related to the limited power source (LPS) protection, the calibrated threshold voltage V_{ref4b_calib} also corresponds to the threshold current Iₒ₂ related to the limited power source (LPS) protection, and the threshold frequency F_{ref5b} also corresponds to the threshold current Iₒ₂ related to the limited power source (LPS) protection. In some examples, the threshold current Iₒ₁ is larger than the threshold current Iₒ₂. For example, the threshold current Iₒ₁ is equal to 3 amps, and the threshold current Iₒ₂ is equal to 1 amp. As an example, each threshold current of the threshold current Iₒ₁ and the threshold current Iₒ₂ is related to the current 293, which is used as an output current of the switched-mode power supply charger 200.

In certain examples, the fast charging protocol chip 220 uses the detected voltage drop from the drain to the source of the transistor 240 when the transistor 240 is turned on to represent the magnitude of the current 293. For example, if the magnitude of the current 293 as represented by the detected voltage drop from the drain to the source of the transistor 240 when the transistor 240 is turned on is larger than the threshold current Iₒ₁, the comparison signal 411 is at the logic high level, and if the magnitude of the current 293 as represented by the detected voltage drop from the drain to the source of the transistor 240 when the transistor 240 is turned on is smaller than or equal to the threshold current Iₒ₁, the comparison signal 411 is at the logic low level. As an example, if the magnitude of the current 293 as represented by the detected voltage drop from the drain to the source of the transistor 240 when the transistor 240 is turned on is larger than the threshold current Iₒ₂, the comparison signal 413 is at the logic high level, and if the magnitude of the current 293 as represented by the detected voltage drop from the drain to the source of the transistor 240 when the transistor 240 is turned on is smaller than or equal to the threshold current Iₒ₂, the comparison signal 413 is at the logic low level.

In some examples, the fast charging protocol chip 220 uses the detected voltage drop from the one terminal of the resistor 230 to the another terminal of the resistor 230 to represent the magnitude of the current 293. For example, if the magnitude of the current 293 as represented by the detected voltage drop from the one terminal of the resistor 230 to the another terminal of the resistor 230 is larger than the threshold current Iₒ₁, the comparison signal 421 is at the logic high level, and if the magnitude of the current 293 as represented by the detected voltage drop from the one terminal of the resistor 230 to the another terminal of the resistor 230 is smaller than or equal to the threshold current Iₒ₁, the comparison signal 421 is at the logic low level. As an example, if the magnitude of the current 293 as represented by the detected voltage drop from the one terminal of the resistor 230 to the another terminal of the resistor 230 is larger than the threshold current Iₒ₂, the comparison signal 423 is at the logic high level, and if the magnitude of the current 293 as represented by the detected voltage drop from the one terminal of the resistor 230 to the another terminal of the resistor 230 is smaller than or equal to the threshold current Iₒ₂, the comparison signal 423 is at the logic low level.

In certain examples, the fast charging protocol chip 220 uses the detected voltage drop from the drain of the transistor 242 to the source of the transistor 242 when the transistor 242 is turned on to represent the magnitude of the current 293. For example, if the magnitude of the current 293 as represented by the detected voltage drop from the drain of the transistor 242 to the source of the transistor 242 when the transistor 242 is turned on is larger than the threshold current Iₒ₁, the comparison signal 431 is at the logic high level, and if the magnitude of the current 293 as represented by the detected voltage drop from the drain of the transistor 242 to the source of the transistor 242 when the transistor 242 is turned on is smaller than or equal to the threshold current Iₒ₁, the comparison signal 431 is at the logic low level. As an example, if the magnitude of the current 293 as represented by the detected voltage drop from the drain of the transistor 242 to the source of the transistor 242 when the transistor 242 is turned on is larger than the threshold current Iₒ₂, the comparison signal 433 is at the logic high level, and if the magnitude of the current 293 as represented by the detected voltage drop from the drain of the transistor 242 to the source of the transistor 242 when the transistor 242 is turned on is smaller than or equal to the threshold current Iₒ₂, the comparison signal 433 is at the logic low level.

In some examples, the fast charging protocol chip 220 uses the detected voltage 445 of the terminal 402 when the transistor 240 is turned on and the USB Type-C output port 250 is connected to a load to represent the magnitude of the current 293. For example, if the magnitude of the current 293 as represented by the detected voltage 445 of the terminal 402 when the transistor 240 is turned on and the USB Type-C output port 250 is connected to a load is larger than the threshold current Iₒ₁, the comparison signal 441 is at the logic high level, and if the magnitude of the current 293 as represented by the detected voltage 445 of the terminal 402 when the transistor 240 is turned on and the USB Type-C output port 250 is connected to a load is smaller than or equal to the threshold current Iₒ₁, the comparison signal 441 is at the logic low level. As an example, if the magnitude of the current 293 as represented by the detected voltage 445 of the terminal 402 when the transistor 240 is turned on and the USB Type-C output port 250 is connected to a load is larger than the threshold current Iₒ₂, the comparison signal 443 is at the logic high level, and if the magnitude of the current 293 as represented by the detected voltage 445 of the terminal 402 when the transistor 240 is turned on and the USB Type-C output port 250 is connected to a load is smaller than or equal to the threshold current Iₒ₂, the comparison signal 443 is at the logic low level.

In some examples, the fast charging protocol chip 220 uses the switching frequency of the switched-mode power supply charger 200 to represent the magnitude of the current 293. For example, if the magnitude of the current 293 as represented by the switching frequency of the switched-mode power supply charger 200 is larger than the threshold current Iₒ₁, the comparison signal 451 is at the logic high level, and if the magnitude of the current 293 as represented by the switching frequency of the switched-mode power supply charger 200 is smaller than or equal to the threshold current Iₒ₁, the comparison signal 451 is at the logic low level. As an example, if the magnitude of the current 293 as represented by the switching frequency of the switched-mode power supply charger 200 is larger than the threshold current Iₒ₂, the comparison signal 453 is at the logic high level, and if the magnitude of the current 293 as represented by the switching frequency of the switched-mode power supply charger 200 is smaller than or equal to the threshold current Iₒ₂, the comparison signal 453 is at the logic low level.

According to some embodiments, the output transistor voltage-drop detector 410 includes an error amplifier 412 and comparators 414 and 416. In certain examples, the error amplifier 412 receives a voltage 415 from the drain of the transistor 240 and also receives a voltage 417 from the source of the transistor 240, wherein the voltage 415 minus the voltage 417 is equal to the voltage drop from the drain of the transistor 240 to the source of the transistor 240. For example, when the transistor 240 is turned on, the voltage drop from the drain of the transistor 240 to the source of the transistor 240 is determined as follows:

$${V}_{ds 1} = {I}_{o} \times {R}_{dson 1} \qquad ( Equation 1 )$$

where V_{ds1} represents the voltage drop from the drain of the transistor 240 to the source of the transistor 240 when the transistor 240 is turned on. Additionally, Iₒ represents the output current of the switched-mode power supply charger 200 when the transistor 240 is turned on, which is equal to the current that flows from the drain of the transistor 240 to the source of the transistor 240 when the transistor 240 is turned on. Moreover, R_{dson1} represents the on-resistance of the transistor 240.

As an example, based at least in part on the voltage drop from the drain of the transistor 240 to the source of the transistor 240 when the transistor 240 is turned on, the error amplifier 412 generates a voltage 419 as follows:

$${V}_{419} = {K}_{1} \times {I}_{o} \times {R}_{dson 1} \qquad ( Equation 2 )$$

where V₄₁₉ represents the voltage 419 when the transistor 240 is turned on. Also, K₁ represents the gain of the error amplifier 412. Additionally, Iₒ represents the output current of the switched-mode power supply charger 200 when the transistor 240 is turned on, and R_{dson1} represents the on-resistance of the transistor 240.

In some examples, the threshold voltage V_{ref1a} and the threshold voltage V_{ref1b} are generated by the logic controller 460 as follows:

$${V}_{ref 1 a} = {K}_{1} \times {I}_{o 1} \times {R}_{dson 1} \qquad ( Equation 3 )$$

$${V}_{ref 1 b} = {K}_{1} \times {I}_{o 2} \times {R}_{dson 1} \qquad ( Equation 4 )$$

where Iₒ₁ represents the threshold current related to the limited power source (LPS) protection that corresponds to the threshold voltage V_{ref1a}, and Iₒ₂ represents the threshold current related to the limited power source (LPS) protection that corresponds to the threshold voltage V_{ref1b}. Also, K₁ represents the gain of the error amplifier 412, and R_{dson1} represents the on-resistance of the transistor 240. For example, the comparator 414 compares the voltage 419 and the threshold voltage V_{ref1a} and generates the comparison signal 411 (e.g., T₁ₐ). As an example, the comparator 416 compares the voltage 419 and the threshold voltage V_{ref1b} and generates the comparison signal 413 (e.g., T_{1b}).

According to certain embodiments, the resistor voltage-drop detector 420 includes an error amplifier 422 and comparators 424 and 426. In some examples, the error amplifier 422 receives a voltage 425 from the one terminal of the resistor 230 and also receives a voltage 427 from the another terminal of the resistor 230, wherein the voltage 425 minus the voltage 427 is equal to the voltage drop from the one terminal of the resistor 230 to the another terminal of the resistor 230. For example, the voltage drop from the one terminal of the resistor 230 to the another terminal of the resistor 230 is determined as follows:

$${V}_{cs} = {I}_{o} \times {R}_{cs} \qquad ( Equation 5 )$$

where V_{cs} represents the voltage drop from the one terminal of the resistor 230 to the another terminal of the resistor 230. Additionally, Iₒ represents the output current of the switched-mode power supply charger 200, which is equal to the current that flows through the resistor 230. Moreover, R_{cs} represents the resistance of the resistor 230. As an example, based at least in part on the voltage drop from the one terminal of the resistor 230 to the another terminal of the resistor 230, the error amplifier 422 generates a voltage 429 as follows:

$${V}_{429} = {K}_{2} \times {I}_{o} \times {R}_{cs} \qquad ( Equation 6 )$$

where V₄₂₉ represents the voltage 429. Also, K₂ represents the gain of the error amplifier 422. Additionally, Iₒ represents the output current of the switched-mode power supply charger 200, and R_{cs} represents the resistance of the resistor 230.

In certain examples, the threshold voltage V_{ref2a} and the threshold voltage V_{ref2b} are generated by the logic controller 460 as follows:

$${V}_{ref 2 a} = {K}_{2} \times {I}_{o 1} \times {R}_{cs} \qquad ( Equation 7 )$$

$${V}_{ref 2 b} = {K}_{2} \times {I}_{o 2} \times {R}_{cs} \qquad ( Equation 8 )$$

where Iₒ₁ represents the threshold current related to the limited power source (LPS) protection that corresponds to the threshold voltage V_{ref2a}, and Iₒ₂ represents the threshold current related to the limited power source (LPS) protection that corresponds to the threshold voltage V_{ref2b}. Also, K₂ represents the gain of the error amplifier 422, and R_{cs} represents the resistance of the resistor 230. For example, the comparator 424 compares the voltage 429 and the threshold voltage V_{ref2a} and generates the comparison signal 421 (e.g., T₂ₐ). As an example, the comparator 426 compares the voltage 429 and the threshold voltage V_{ref2b} and generates the comparison signal 423 (e.g., T_{2b}).

According to some embodiments, the synchronous rectification voltage-drop detector 430 includes an error amplifier 432 and comparators 434 and 436. In certain examples, the error amplifier 432 receives a voltage 435 from the drain of the transistor 242 through the resistor 232 and also receives a voltage 437 (e.g., the ground voltage) at the source of the transistor 242, wherein the voltage 435 minus the voltage 437 is equal to the voltage drop from the drain of the transistor 242 to the source of the transistor 242. For example, when the transistor 242 is turned on, the voltage drop from the drain of the transistor 242 to the source of the transistor 242 is determined as follows:

$${V}_{ds 2} = {I}_{o} \times {R}_{dson 2} \qquad ( Equation 9 )$$

where V_{ds2} represents the voltage drop from the drain of the transistor 242 to the source of the transistor 242 when the transistor 242 is turned on. Additionally, Iₒ represents the output current of the switched-mode power supply charger 200 when the transistor 242 is turned on, which is equal to the current that flows from the drain of the transistor 242 to the source of the transistor 242 when the transistor 242 is turned on. Moreover, R_{dson2} represents the on-resistance of the transistor 242. As an example, based at least in part on the voltage drop from the drain of the transistor 242 to the source of the transistor 242 when the transistor 242 is turned on, the error amplifier 432 generates a voltage 439 as follows:

$${V}_{439} = {K}_{3} \times {I}_{o} \times {R}_{dson 2} \qquad ( Equation 10 )$$

where V₄₃₉ represents the voltage 439 when the transistor 242 is turned on. Also, K₃ represents the gain of the error amplifier 432. Additionally, Iₒ represents the output current of the switched-mode power supply charger 200 when the transistor 242 is turned on, and R_{dson2} represents the on-resistance of the transistor 242.

In some examples, the threshold voltage V_{ref3a} and the threshold voltage V_{ref3b} are generated by the logic controller 460 as follows:

$${V}_{ref 3 a} = {K}_{3} \times {I}_{o 1} \times {R}_{dson 2} \qquad ( Equation 11 )$$

$${V}_{ref 3 b} = {K}_{3} \times {I}_{o 2} \times {R}_{dson 2} \qquad ( Equation 12 )$$

where Iₒ₁ represents the threshold current related to the limited power source (LPS) protection that corresponds to the threshold voltage V_{ref3a}, and Iₒ₂ represents the threshold current related to the limited power source (LPS) protection that corresponds to the threshold voltage V_{ref3b}. Also, K₃ represents the gain of the error amplifier 432, and R_{dson2} represents the on-resistance of the transistor 242. For example, the comparator 434 compares the voltage 439 and the threshold voltage V_{ref3a} and generates the comparison signal 431 (e.g., T₃ₐ). As an example, the comparator 436 compares the voltage 439 and the threshold voltage V_{ref3b} and generates the comparison signal 433 (e.g., T_{3b}).

According to certain embodiments, the switching frequency detector 450 includes a frequency sampling unit 452 and a frequency comparing unit 454. In some examples, the switching frequency detector 450 (e.g., the frequency sampling unit 452) receives the voltage 435 from the drain of the transistor 242 through the resistor 232. For example, the frequency sampling unit 452 determines the switching frequency of the switched-mode power supply charger 200 based at least in part on the voltage 435. As an example, the frequency sampling unit 452 generates a signal 459 that indicates the determined switching frequency of the switched-mode power supply charger 200. In certain examples, the frequency comparing unit 454 receives the signal 459 that indicates the determined switching frequency of the switched-mode power supply charger 200. For example, the frequency comparing unit 454 compares the determined switching frequency of the switched-mode power supply charger 200 with the threshold frequency F_{ref5a} and generates the comparison signal 451 (e.g., T₅ₐ). As an example, the frequency comparing unit 454 also compares the determined switching frequency of the switched-mode power supply charger 200 with the threshold frequency F_{ref5b} and generates the comparison signal 453 (e.g., T_{5b}).

In some examples, the fast charging protocol communication detector 440 includes a current source 442, a voltage sample-and-hold unit 444, a voltage sample-and-hold unit 446, comparators 448 and 468, a calibration unit 466. In certain examples, the logic controller 460 generates the threshold voltage V_{ref1a}, the threshold voltage V_{ref1b}, the threshold voltage V_{ref2a}, the threshold voltage V_{ref2b}, the threshold voltage V_{ref3a}, the threshold voltage V_{ref3b}, a threshold voltage V_{ref4a} without calibration, a threshold voltage V_{ref4b} without calibration, the threshold frequency F_{ref5a}, and the threshold frequency F_{ref5b}. For example, the threshold voltage V_{ref4a} without calibration is larger than the threshold voltage V_{ref4b} without calibration. As an example, the threshold voltage V_{ref4a} without calibration corresponds to the threshold current Iₒ₁ related to the limited power source (LPS) protection. and the threshold voltage V_{ref4b} without calibration corresponds to the threshold current Iₒ₂ related to the limited power source (LPS) protection.

In certain embodiments, the frequency sampling unit 452 is implemented using one or more software components, one or more hardware components, and/or one or more combinations of software and hardware components. In some embodiments, the frequency comparing unit 454 is implemented using one or more software components, one or more hardware components, and/or one or more combinations of software and hardware components. In certain embodiments, the voltage sample-and-hold unit 444 is implemented using one or more software components, one or more hardware components, and/or one or more combinations of software and hardware components. In some embodiments, the voltage sample-and-hold unit 446 is implemented using one or more software components, one or more hardware components, and/or one or more combinations of software and hardware components. In certain embodiments, the calibration unit 466 is implemented using one or more software components, one or more hardware components, and/or one or more combinations of software and hardware components.

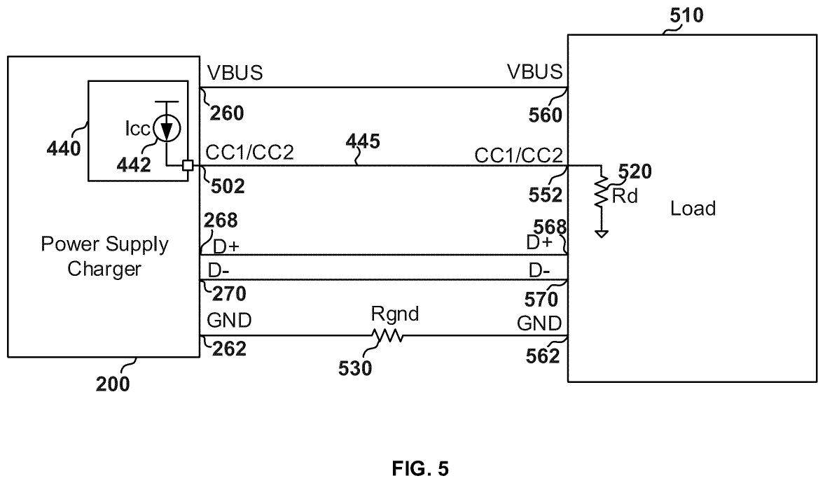

FIG. 5 is a simplified diagram showing the switched-mode power supply charger 200 as shown in FIG. 2, FIG. 3 and FIG. 4 that is connected to a load according to some embodiments of the present disclosure. This diagram is merely an example, which should not unduly limit the scope of the claims. One of ordinary skill in the art would recognize many variations, alternatives, and modifications. The switched-mode power supply charger 200 is connected to a load 510 (e.g., a mobile electronic device) through a USB Type-C output port (e.g., the USB Type-C output port 250). In certain examples, the switched-mode power supply charger 200 includes the fast charging protocol communication detector 440 that includes the current source 442, and the switched-mode power supply charger 200 also includes the pin 260, the pin 268, the pin 270, the pin 262, and a pin 502, wherein the pin 502 is either the pin 264 (e.g., CC1) or the pin 266 (e.g., CC2). For example, the pin 502 is connected to the terminal 402, which is either the terminal 326 or the terminal 328. As an example, the terminal 326 (e.g., a pin) is connected to the pin 264, and the terminal 328 (e.g., a pin) is connected to the pin 266. In some examples, the load 510 (e.g., a mobile electronic device) includes a resistor 520 (e.g., R_{d}), and the load 510 (e.g., a mobile electronic device) also includes a pin 560, a pin 568, a pin 570, a pin 562, and a pin 552, wherein the pin 552 is either a pin for CC1 or a pin for CC2. Although the above has been shown using a selected group of components, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain examples, the pin 260 is connected to the pin 560, the pin 268 is connected to the pin 568, and the pin 270 is connected to the pin 570. In some examples, the pin 262 is connected to the pin 562 through a resistor 530 (e.g., R_{gnd}). For example, the resistor 530 (e.g., R_{gnd}) includes two terminals. As an example, one terminal of the two terminals of the resistor 530 is connected to the pin 262, and the other terminal of the two terminals of the resistor 530 is connected to the pin 562. In certain examples, the pin 502 is connected to the pin 552. For example, if the pin 502 is the pin 264 (e.g., CC1), the pin 552 is a pin for CC1. As an example, if the pin 502 is the pin 266 (e.g., CC2), the pin 552 is a pin for CC2.

As shown in FIG. 4 and FIG. 5, the current source 442 generates a current 447 (e.g., I_{cc}), which flows through the terminal 402, the pin 502, the pin 552, and the resistor 520 (e.g., R_{d}) to generate the voltage 445 according to certain embodiments. For example, the voltage 445 is determined as follows:

$${V}_{445} = {I}_{cc} \times {R}_{d} \qquad ( Equation 13 )$$

where V₄₄₅ represents the voltage 445. Additionally, Ice represents the current 447, and R_{d} represents the resistance of the resistor 520. As an example, if the voltage 445 falls within a predetermined range, the connection between the switched-mode power supply charger 200 and the load 510 (e.g., a mobile electronic device) is determined to be proper.

According to some embodiments, the fast charging protocol communication detector 440 receives the voltage 445. For example, the voltage sample-and-hold unit 444 samples the voltage 445 when the transistor 240 is turned off and the switched-mode power supply charger 200 is connected to the load 510, and the voltage sample-and-hold unit 444 holds the sampled voltage as a voltage 467. As an example, the voltage sample-and-hold unit 446 samples the voltage 445 when the transistor 240 is turned on and the switched-mode power supply charger 200 is connected to the load 510, and the voltage sample-and-hold unit 446 holds the sampled voltage as a voltage 469.

In certain embodiments, the logic controller 460 generates the threshold voltage V_{ref4a} without calibration and the threshold voltage V_{ref4b} without calibration as follows:

$${V}_{ref 4 a} = {I}_{o 1} \times {R}_{gnd} \qquad ( Equation 14 )$$

$${V}_{ref 4 b} = {I}_{o 2} \times {R}_{gnd} \qquad ( Equation 15 )$$

where Iₒ₁ represents the threshold current related to the limited power source (LPS) protection that corresponds to the threshold voltage V_{ref4a}, and Iₒ₂ represents the threshold current related to the limited power source (LPS) protection that corresponds to the threshold voltage V_{ref4b}. Also, R_{gnd} represents the resistance of the resistor 530.

In some embodiments, the voltage 467 is used by the calibration unit 466 to calibrate the threshold voltage V_{ref4a} and the threshold voltage V_{ref4b} in order to generate the calibrated threshold voltage V_{ref4a_calib} and the calibrated threshold voltage V_{ref4b_calib} as follows:

$${V}_{ref 4 a \_ calib} = {V}_{467} + {I}_{o 1} \times {R}_{gnd} \qquad ( Equation 16 )$$

$${V}_{ref 4 b \_ calib} = {V}_{467} + {I}_{o 2} \times {R}_{gnd} \qquad ( Equation 17 )$$

where V₄₆₇ represents the voltage 467, which is equal to the sampled voltage 445 when the transistor 240 is turned off and the switched-mode power supply charger 200 is connected to the load 510. Additionally, Iₒ₁ represents the threshold current related to the limited power source (LPS) protection that corresponds to the calibrated threshold voltage V_{ref4a_calib}, and Iₒ₂ represents the threshold current related to the limited power source (LPS) protection that corresponds to the calibrated threshold voltage V_{ref4b_calib}. Also, R_{gnd} represents the resistance of the resistor 530.

In some embodiments, when the transistor 240 is turned on and the switched-mode power supply charger 200 is connected to the load 510, the voltage 469 is determined as follows:

$${V}_{469} = {V}_{467} + {I}_{o} \times {R}_{gnd} \qquad ( Equation 18 )$$

where V₄₆₉ represents the voltage 469, which is equal to the sampled voltage 445 when the transistor 240 is turned on and the switched-mode power supply charger 200 is connected to the load 510, and V₄₆₇ represents the voltage 467, which is equal to the sampled voltage 445 when the transistor 240 is turned off and the switched-mode power supply charger 200 is connected to the load 510. Additionally, Iₒ represents the output current of the switched-mode power supply charger 200 when the transistor 242 is turned on, which is equal to the current that flows from the drain of the transistor 242 to the source of the transistor 242 when the transistor 242 is turned on. Moreover, R_{gnd} represents the resistance of the resistor 530. For example, the comparator 448 compares the voltage 469 and the calibrated threshold voltage V_{ref4a_calib} and generates the comparison signal 441 (e.g., T₄ₐ). As an example, the comparator 468 compares the voltage 469 and the calibrated threshold voltage V_{ref4b_calib} and generates the comparison signal 443 (e.g., T_{4b}).

As shown in FIG. 4, the threshold voltage V_{ref1a}, the threshold voltage V_{ref2a}, the threshold voltage V_{ref3a}, the calibrated threshold voltage V_{ref4a_calib}, and the threshold frequency F_{ref5a} all correspond to the same threshold current Iₒ₁ related to the limited power source (LPS) protection, and the threshold voltage V_{ref1b}, the threshold voltage V_{ref2b}, the threshold voltage V_{ref3b}, the calibrated threshold voltage V_{ref4b_calib}, and the threshold frequency F_{ref5b} all correspond to the same threshold current Iₒ₂ related to the limited power source (LPS) protection according to certain embodiments. For example, the comparison signal 411 and the comparison signal 413 correspond to one combination of three potential combinations; the comparison signal 411 is at the logic high level and the comparison signal 413 is also at the logic high level; the comparison signal 411 is at the logic low level but the comparison signal 413 is at the logic high level; the comparison signal 411 is at the logic low level and the comparison signal 413 is also at the logic low level. As an example, the comparison signal 421 and the comparison signal 423 correspond to one combination of three potential combinations; the comparison signal 421 is at the logic high level and the comparison signal 423 is also at the logic high level; the comparison signal 421 is at the logic low level but the comparison signal 423 is at the logic high level; the comparison signal 421 is at the logic low level and the comparison signal 423 is also at the logic low level. For example, the comparison signal 431 and the comparison signal 433 correspond to one combination of three potential combinations: the comparison signal 431 is at the logic high level and the comparison signal 433 is also at the logic high level; the comparison signal 431 is at the logic low level but the comparison signal 433 is at the logic high level; the comparison signal 431 is at the logic low level and the comparison signal 433 is also at the logic low level. As an example, the comparison signal 441 and the comparison signal 443 correspond to one combination of three potential combinations; the comparison signal 441 is at the logic high level and the comparison signal 443 is also at the logic high level; the comparison signal 441 is at the logic low level but the comparison signal 443 is at the logic high level; the comparison signal 441 is at the logic low level and the comparison signal 443 is also at the logic low level. For example, the comparison signal 451 and the comparison signal 453 correspond to one combination of three potential combinations: the comparison signal 451 is at the logic high level and the comparison signal 453 is also at the logic high level; the comparison signal 451 is at the logic low level but the comparison signal 453 is at the logic high level; the comparison signal 451 is at the logic low level and the comparison signal 453 is also at the logic low level.

In some embodiments, the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are all the same. For example, all of the comparison signal 411, the comparison signal 421, the comparison signal 431, the comparison signal 441, and the comparison signal 451 are at the logic high level, and all of the comparison signal 413, the comparison signal 423, the comparison signal 433, the comparison signal 443, and the comparison signal 453 are also at the logic high level, so the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are all the same. As an example, all of the comparison signal 411, the comparison signal 421, the comparison signal 431, the comparison signal 441, and the comparison signal 451 are at the logic low level, and all of the comparison signal 413, the comparison signal 423, the comparison signal 433, the comparison signal 443, and the comparison signal 453 are also at the logic high level, so the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are all the same. For example, all of the comparison signal 411, the comparison signal 421, the comparison signal 431, the comparison signal 441, and the comparison signal 451 are at the logic low level, and all of the comparison signal 413, the comparison signal 423, the comparison signal 433, the comparison signal 443, and the comparison signal 453 are also at the logic low level, so the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are all the same.

In certain embodiments, the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are not all the same. For example, at least one signal of the comparison signal 411, the comparison signal 421, the comparison signal 431, the comparison signal 441, and the comparison signal 451 is at the logic high level, and at least one signal of the comparison signal 411, the comparison signal 421, the comparison signal 431, the comparison signal 441, and the comparison signal 451 is at the logic low level, so the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are not all the same. As an example, at least one signal of the comparison signal 413, the comparison signal 423, the comparison signal 433, the comparison signal 443, and the comparison signal 453 is at the logic high level, and at least one signal of the comparison signal 413, the comparison signal 423, the comparison signal 433, the comparison signal 443, and the comparison signal 453 is at the logic low level, so the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are not all the same.

According to some embodiments, if the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are all the same, then none of the following faults have occurred: there is a short circuit between the drain of the transistor 240 and the source of the transistor 240 related to the output transistor voltage-drop detector 410, there is a short circuit between the one terminal of the resistor 230 and the another terminal of the resistor 230 related to the resistor voltage-drop detector 420, there is a short circuit between the drain of the transistor 242 and the source of the transistor 242 related to the synchronous rectification voltage-drop detector 430, there is a short circuit between the two terminals of the resistor 530 (e.g., R_{gnd}) related to the fast charging protocol communication detector 440, and/or there is a failure in using the drain of the transistor 242 to detect the switching frequency related to the switching frequency detector 450. For example, if the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are the same, then there is no short circuit between the drain of the transistor 240 and the source of the transistor 240 related to the output transistor voltage-drop detector 410, there is no short circuit between the one terminal of the resistor 230 and the another terminal of the resistor 230 related to the resistor voltage-drop detector 420, there is no short circuit between the drain of the transistor 242 and the source of the transistor 242 related to the synchronous rectification voltage-drop detector 430, there is no short circuit between the two terminals of the resistor 530 (e.g., R_{gnd}) related to the fast charging protocol communication detector 440, and there is no failure in using the drain of the transistor 242 to detect the switching frequency related to the switching frequency detector 450.

According to certain embodiments, if the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are all the same, the fast charging protocol chip 220 detects the voltage drop from the one terminal of the resistor 230 to the another terminal of the resistor 230 to determine the magnitude of the current 293, which is used as an output current of the switched-mode power supply charger 200. For example, if the fast charging protocol chip 220 determines that the output current of the switched-mode power supply charger 200 exceeds a predetermined current threshold for the limited power source (LPS) protection and/or the output power of the switched-mode power supply charger 200 exceeds a predetermined power threshold for the limited power source (LPS) protection, the fast charging protocol chip 220 outputs the signal 463 at the terminal 322 to turn off the transistor 240 in order to achieve the limited power source (LPS) protection.

In some embodiments, if the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are not all the same, then one or more of the following faults have occurred: there is a short circuit between the drain of the transistor 240 and the source of the transistor 240 related to the output transistor voltage-drop detector 410, there is a short circuit between the one terminal of the resistor 230 and the another terminal of the resistor 230 related to the resistor voltage-drop detector 420, there is a short circuit between the drain of the transistor 242 and the source of the transistor 242 related to the synchronous rectification voltage-drop detector 430, there is a short circuit between the two terminals of the resistor 530 (e.g., R_{gnd}) related to the fast charging protocol communication detector 440, and/or there is a failure in using the drain of the transistor 242 to detect the switching frequency related to the switching frequency detector 450.

For example, the existence of a fault related to the transistor 240 includes the existence of a short circuit between the drain of the transistor 240 and the source of the transistor 240 related to the output transistor voltage-drop detector 410. As an example, the existence of a fault related to the resistor 230 includes the existence of a short circuit between the one terminal of the resistor 230 and the another terminal of the resistor 230 related to the resistor voltage-drop detector 420. For example, the existence of a fault related to the transistor 242 includes the existence of a short circuit between the drain of the transistor 242 and the source of the transistor 242 related to the synchronous rectification voltage-drop detector 430. As an example, the existence of a fault related to the voltage 445 includes the existence of a short circuit between the two terminals of the resistor 530 (e.g., R_{gnd}) related to the fast charging protocol communication detector 440. For example, the existence of a fault related to the switching frequency includes the existence of a failure in using the drain of the transistor 242 to detect the switching frequency related to the switching frequency detector 450.

In certain embodiments, if the combination that corresponds to the comparison signal 411 and the comparison signal 413, the combination that corresponds to the comparison signal 421 and the comparison signal 423, the combination that corresponds to the comparison signal 431 and the comparison signal 433, the combination that corresponds to the comparison signal 441 and the comparison signal 443, and the combination that corresponds to the comparison signal 451 and the comparison signal 453 are not all the same, the switched-mode power supply charger 200 reduces the output power of the switched-mode power supply charger 200 and/or the output current of the switched-mode power supply charger 200 in order to achieve the limited power source (LPS) protection. In some examples, if there is no short circuit between the drain of the transistor 240 and the source of the transistor 240 related to the output transistor voltage-drop detector 410, to reduce the output power of the switched-mode power supply charger 200 and/or the output current of the switched-mode power supply charger 200, the logic controller 460 uses the signal 463 to turn off the transistor 240 in order to achieve the limited power source (LPS) protection. In certain examples, if there is a short circuit between the drain of the transistor 240 and the source of the transistor 240 related to the output transistor voltage-drop detector 410, the logic controller 460 uses the signal 461 and/or the signal 465 to reduce the output power of the switched-mode power supply charger 200 and/or the output current of the switched-mode power supply charger 200 in order to achieve the limited power source (LPS) protection. For example, if there is a short circuit between the drain of the transistor 240 and the source of the transistor 240 related to the output transistor voltage-drop detector 410, the logic controller 460 uses the signal 461 to communicate with the pulse-width-modulation controller 210 through the optocoupler that includes the optocoupler emitter 252 and the optocoupler receiver 254, and in response, the pulse-width-modulation controller 210 reduces the output power of the switched-mode power supply charger 200 and/or the output current of the switched-mode power supply charger 200 to achieve the limited power source (LPS) protection. As an example, if there is a short circuit between the drain of the transistor 240 and the source of the transistor 240 related to the output transistor voltage-drop detector 410, the logic controller 460 uses the signal 465 to communicate with the pulse-width-modulation controller 210 through the transistor 242, and in response, the pulse-width-modulation controller 210 reduces the output power of the switched-mode power supply charger 200 and/or the output current of the switched-mode power supply charger 200 to achieve the limited power source (LPS) protection.

As mentioned above and further emphasized here, FIG. 4 is merely an example, which should not unduly limit the scope of the claims. One of ordinary skill in the art would recognize many variations, alternatives, and modifications. In some examples, one or more detectors (e.g., the output transistor voltage-drop detector 410, the resistor voltage-drop detector 420, the synchronous rectification voltage-drop detector 430, the fast charging protocol communication detector 440, and/or the switching frequency detector 450) are removed from the switched-mode power supply charger 200. For example, among the output transistor voltage-drop detector 410, the resistor voltage-drop detector 420, the synchronous rectification voltage-drop detector 430, the fast charging protocol communication detector 440, and the switching frequency detector 450, one detector is removed from the switched-mode power supply charger 200, and the logic controller 460 uses the remaining detectors for the limited power source (LPS) protection. As an example, among the output transistor voltage-drop detector 410, the resistor voltage-drop detector 420, the synchronous rectification voltage-drop detector 430, the fast charging protocol communication detector 440, and the switching frequency detector 450, two detectors are removed from the switched-mode power supply charger 200, and the logic controller 460 uses the remaining detectors for the limited power source (LPS) protection. For example, among the output transistor voltage-drop detector 410, the resistor voltage-drop detector 420, the synchronous rectification voltage-drop detector 430, the fast charging protocol communication detector 440, and the switching frequency detector 450, three detectors are removed from the switched-mode power supply charger 200, and the logic controller 460 uses the remaining detectors for the limited power source (LPS) protection. In some examples, one or more detectors (e.g., the output transistor voltage-drop detector 410, the resistor voltage-drop detector 420, the synchronous rectification voltage-drop detector 430, the fast charging protocol communication detector 440, and/or the switching frequency detector 450) are not on the fast charging protocol chip 220, but the one or more detectors remain to be parts of the switched-mode power supply charger 200.

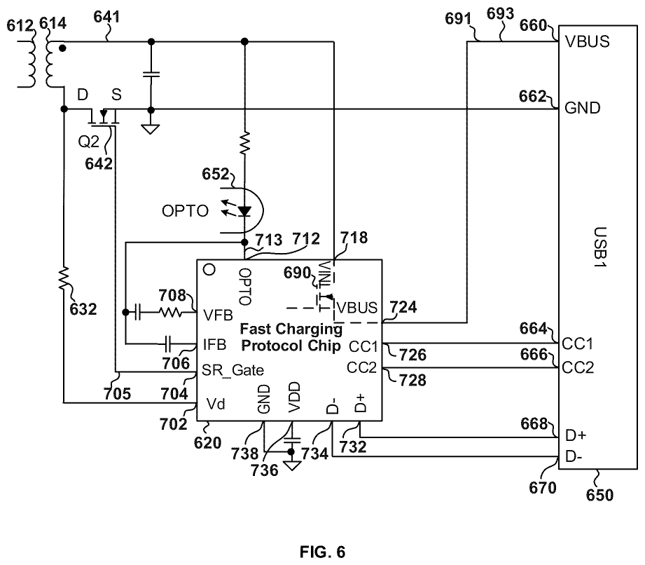

Additionally, as mentioned above and further emphasized here, FIG. 2, FIG. 3, and FIG. 4 are merely examples, which should not unduly limit the scope of the claims. One of ordinary skill in the art would recognize many variations, alternatives, and modifications. For example, the resistors 230 and 234 are removed from the switched-mode power supply charger 200, and the terminals 314, 316 and 322 are also removed from the fast charging protocol chip 220 of the switched-mode power supply charger 200, as shown in FIG. 6.

FIG. 6 is a simplified diagram showing certain components of a switched-mode power supply charger according to certain embodiments of the present disclosure. This diagram is merely an example, which should not unduly limit the scope of the claims. One of ordinary skill in the art would recognize many variations, alternatives, and modifications. The switched-mode power supply charger includes a primary winding 612, a secondary winding 614, a fast charging protocol chip 620, a resistor 632, a transistor 642, a USB Type-C output port 650, and an optocoupler emitter 652. For example, the USB Type-C output port 650 includes pins 660, 662, 664, 666, 668 and 670. As an example, the fast charging protocol chip 620 includes terminals (e.g., pins) 702, 704, 706, 708, 712, 718, 724, 726, 728, 732, 734, 736, and 738. For example, the fast charging protocol chip 620 (e.g., a fast charging protocol controller) includes a transistor combination 690. As an example, the primary winding 612 and the secondary winding 614 are coupled to each other. Although the above has been shown using a selected group of components for the switched-mode power supply charger, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to some embodiments, the switched-mode power supply charger is configured to achieve the limited power source (LPS) protection even if one or more faults related to the limited power source (LPS) protection exist in the switched-mode power supply charger. According to certain embodiments, the fast charging protocol chip 620 includes a circuit for detecting one or more faults related to the limited power source (LPS) protection.

In some embodiments, the pin 660 is the same as the pin 260, the pin 662 is the same as the pin 262, the pin 664 is the same as the pin 264, the pin 666 is the same as the pin 266, the pin 668 is the same as the pin 268, and the pin 670 is the same as the pin 270. In certain embodiments, the terminal (e.g., a pin) 702 is the same as the terminal (e.g., a pin) 302, the terminal (e.g., a pin) 704 is the same as the terminal (e.g., a pin) 304, the terminal (e.g., a pin) 706 is the same as the terminal (e.g., a pin) 306, the terminal (e.g., a pin) 708 is the same as the terminal (e.g., a pin) 308, the terminal (e.g., a pin) 712 is the same as the terminal (e.g., a pin) 312, the terminal (e.g., a pin) 718 is the same as the terminal (e.g., a pin) 318, the terminal (e.g., a pin) 724 is the same as the terminal (e.g., a pin) 324, the terminal (e.g., a pin) 726 is the same as the terminal (e.g., a pin) 326, the terminal (e.g., a pin) 728 is the same as the terminal (e.g., a pin) 328, the terminal (e.g., a pin) 732 is the same as the terminal (e.g., a pin) 332, the terminal (e.g., a pin) 734 is the same as the terminal (e.g., a pin) 334, the terminal (e.g., a pin) 736 is the same as the terminal (e.g., a pin) 336, and the terminal (e.g., a pin) 738 is the same as the terminal (e.g., a pin) 338.

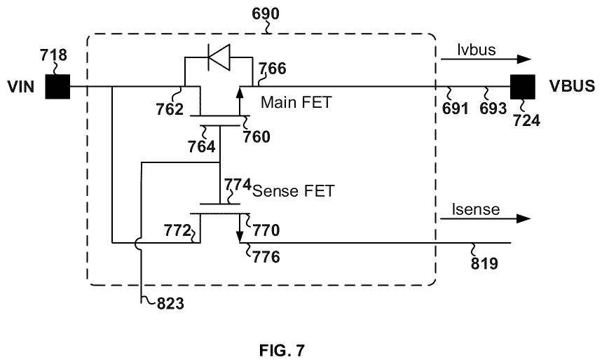

In some examples, the fast charging protocol chip 620 includes the transistor combination 690 as shown in FIG. 7. For example, the terminal (e.g., a pin) 718 of the fast charging protocol chip 620 is biased to a voltage 641. As an example, the terminal 704 (e.g., a pin) of the fast charging protocol chip 620 outputs a signal 705, and the terminal 712 (e.g., a pin) of the fast charging protocol chip 620 outputs a signal 713. In certain examples, the pin 660 of the USB Type-C output port 650 receives a voltage 691 and a current 693. For example, the voltage 691 is used as an output voltage of the switched-mode power supply charger, and the current 693 is used as an output current of the switched-mode power supply charger. As an example, the output power of the switched-mode power supply charger is equal to the voltage 691 multiplied by the current 693.

FIG. 7 is a simplified diagram showing the transistor combination 690 of the switched-mode power supply charger as shown in FIG. 6 according to some embodiments of the present disclosure. This diagram is merely an example, which should not unduly limit the scope of the claims. One of ordinary skill in the art would recognize many variations, alternatives, and modifications. The transistor combination 690 includes a transistor 760 and a transistor 770. Although the above has been shown using a selected group of components for the transistor combination, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain embodiments, the transistor 760 (e.g., a field-effect transistor) includes a drain 762, a gate 764 and a source 766, and the transistor 770 (e.g., a field-effect transistor) includes a drain 772, a gate 774 and a source 776. For example, both of the gate 764 of the transistor 760 and the gate 774 of the transistor 770 receive a signal 823. As an example, the signal 823 is used to turn on and/or turn off the transistor 760 and is used to turn on and/or turn off the transistor 770. In some examples, the drain 762 of the transistor 760 is connected to the terminal (e.g., a pin) 718 of the fast charging protocol chip 620 and is biased to the voltage 641. In certain examples, the source 766 of the transistor 760 is connected to the terminal (e.g., a pin) 724 of the fast charging protocol chip 620, which outputs the voltage 691 and the current 693. For example, the voltage 691 is equal to the voltage at the source 766 of the transistor 760. As an example, the current 693 is equal to the current that flows from the drain 762 of the transistor 760 to the source 766 of the transistor 760 when the transistor 760 is turned on.

In some embodiments, the transistor 760 is the same as the transistor 240. For example, the transistor 770 is used to sample the current that flows from the drain 762 of the transistor 760 to the source 766 of the transistor 760 when the transistor 760 is turned on. As an example, the current that flows from the drain 772 of the transistor 770 to the source 776 of the transistor 770 is determined as follows:

$${I}_{770} = \frac{1}{N} \times {I}_{760} \qquad ( Equation 19 )$$

where I₇₇₀ represents the current that flows from the drain 772 of the transistor 770 to the source 776 of the transistor 770, and I₇₆₀ represents the current that flows from the drain 762 of the transistor 760 to the source 766 of the transistor 760. N is a predetermined constant. In certain examples, the current (e.g., I₇₆₀) that flows from the drain 762 of the transistor 760 to the source 766 of the transistor 760 is equal to the current 693. In some examples, N is equal to 1000, so if the current (e.g., I₇₆₀) that flows from the drain 762 of the transistor 760 to the source 766 of the transistor 760 is equal to 3 A, the current (e.g., I₇₇₀) that flows from the drain 772 of the transistor 770 to the source 776 of the transistor 770 is equal to 3 mA.

In certain embodiments, the current (e.g., I₇₇₀) that flows from the drain 772 of the transistor 770 to the source 776 of the transistor 770 is used as a current 819, which is outputted by the transistor 770. For example, the current 819 is equal to the current (e.g., I₇₇₀) that flows from the drain 772 to the source 776 of the transistor 770. As an example, the current 693 is equal to the current (e.g., I₇₆₀) that flows from the drain 762 to the source 766 of the transistor 760, wherein the current 693 is used as the output current of the switched-mode power supply charger. In some examples, the current (e.g., I₇₇₀) that flows from the drain 772 to the source 776 of the transistor 770 is compared with a threshold current that corresponds to the threshold current Iₒ₁ related to the limited power source (LPS) protection and is also compared to another threshold current that corresponds to the threshold current Iₒ₂ related to the limited power source (LPS) protection.

Some embodiments of the present disclosure provide a switched-mode power supply charger (e.g., the switched-mode power supply charger 200) that can achieve the limited power source (LPS) protection even if one or more faults related to the limited power source (LPS) protection exist in the switched-mode power supply charger (e.g., the switched-mode power supply charger 200). For example, one fault related to the limited power source (LPS) protection of the switched-mode power supply charger 200 is a short circuit between the drain of the transistor 240 and the source of the transistor 240. As an example, one fault related to the limited power source (LPS) protection of the switched-mode power supply charger 200 is a short circuit between the one terminal of the resistor 230 and the another terminal of the resistor 230. For example, one fault related to the limited power source (LPS) protection of the switched-mode power supply charger 200 is a short circuit between the drain of the transistor 242 and the source of the transistor 242. As an example, one fault related to the limited power source (LPS) protection of the switched-mode power supply charger 200 is a short circuit between the two terminals of the resistor 530 (e.g., R_{gnd}). For example, one fault related to the limited power source (LPS) protection of the switched-mode power supply charger 200 is a failure in using the drain of the transistor 242 to detect the switching frequency.

According to certain embodiments, a fast charging protocol controller for a power supply charger includes: a first transistor voltage-drop detector configured to detect a first transistor voltage drop from a first drain of a first transistor to a first source of the first transistor, the first transistor being configured to provide an output current of the power supply charger and an output voltage of the power supply charger; a resistor voltage-drop detector configured to detect a resistor voltage drop from a first resistor terminal of a first resistor to a second resistor terminal of the first resistor, the first resistor being configured to receive a resistor current that is equal to the output current in magnitude; and a logic controller coupled to the first transistor voltage-drop detector and the resistor voltage-drop detector; wherein the first transistor voltage-drop detector is further configured to: compare the detected first transistor voltage drop with a first threshold voltage to generate a first comparison signal; and compare the detected first transistor voltage drop with a second threshold voltage to generate a second comparison signal; wherein the resistor voltage-drop detector is further configured to: compare the detected resistor voltage drop with a third threshold voltage to generate a third comparison signal; and compare the detected resistor voltage drop with a fourth threshold voltage to generate a fourth comparison signal; the logic controller is further configured to: receive the first comparison signal and the second comparison signal from the first transistor voltage-drop detector; receive the third comparison signal and the fourth comparison signal from the resistor voltage-drop detector; determine, based at least in part on the first comparison signal, the second comparison signal, the third comparison signal and the fourth comparison signal, whether or not a first fault related to the first transistor exists and whether or not a second fault related to the first resistor exists; and output, based at least in part on whether or not the first fault exists and whether or not the second fault exists, at least one or more control signals related to a limited power source protection for the power supply charger. For example, the fast charging protocol controller is implemented according to at least FIG. 2, FIG. 3, FIG. 4, and/or FIG. 5.

As an example, the first threshold voltage is larger than the second threshold voltage; and the third threshold voltage is larger than the fourth threshold voltage. For example, the fast charging protocol controller further includes: a second transistor voltage-drop detector configured to detect a second transistor voltage drop from a second drain of a second transistor to a second source of the second transistor, the second transistor being connected to a secondary winding of the power supply charger; wherein the second transistor voltage-drop detector is further configured to: compare the detected second transistor voltage drop with a fifth threshold voltage to generate a fifth comparison signal; and compare the detected second transistor voltage drop with a sixth threshold voltage to generate a sixth comparison signal. As an example, the fifth threshold voltage is larger than the sixth threshold voltage. For example, the logic controller is further configured to: receive the fifth comparison signal and the sixth comparison signal from the second transistor voltage-drop detector; determine, based at least in part on the first comparison signal, the second comparison signal, the third comparison signal, the fourth comparison signal, the fifth comparison signal and the sixth comparison signal, whether or not the first fault related to the first transistor exists, whether or not the second fault related to the first resistor exists, and whether or not a third fault related to the second transistor exists; and output, based at least in part on whether or not the first fault exists, whether or not the second fault exists, and whether or not the third fault exists, at least the one or more control signals related to the limited power source protection for the power supply charger.

As an example, the fast charging protocol controller further includes: a voltage detector configured to detect an input voltage related to a load connected to the power supply charger; wherein the voltage detector is further configured to: compare the detected input voltage with a seventh threshold voltage to generate a seventh comparison signal; and compare the detected input voltage with an eighth threshold voltage to generate an eighth comparison signal. For example, the seventh threshold voltage is larger than the eighth threshold voltage. As an example, the logic controller is further configured to: receive the seventh comparison signal and the eighth comparison signal from the voltage detector; determine, based at least in part on the first comparison signal, the second comparison signal, the third comparison signal, the fourth comparison signal, the fifth comparison signal, the sixth comparison signal, the seventh comparison signal and the eighth comparison signal, whether or not the first fault related to the first transistor exists, whether or not the second fault related to the first resistor exists, whether or not the third fault related to the second transistor exists, and whether or not a fourth fault related to the input voltage exists; and output, based at least in part on whether or not the first fault exists, whether or not the second fault exists, whether or not the third fault exists, and whether or not the fourth fault exists, at least the one or more control signals related to the limited power source protection for the power supply charger. For example, the fast charging protocol controller further includes: a frequency detector configured to detect a switching frequency related to the power supply charger; wherein the frequency detector is further configured to: compare the detected switching frequency with a first threshold frequency to generate a ninth comparison signal; and compare the detected switching frequency with a second threshold frequency to generate a tenth comparison signal. As an example, the first threshold frequency is larger than the second threshold frequency. For example, the logic controller is further configured to: receive the ninth comparison signal and the tenth comparison signal from the frequency detector; determine, based at least in part on the first comparison signal, the second comparison signal, the third comparison signal, the fourth comparison signal, the fifth comparison signal, the sixth comparison signal, the seventh comparison signal, the eighth comparison signal, the ninth comparison signal and the tenth comparison signal, whether or not the first fault related to the first transistor exists, whether or not the second fault related to the first resistor exists, whether or not the third fault related to the second transistor exists, whether or not the fourth fault related to the input voltage exists, and whether or not a fifth fault related to the switching frequency exists; and output, based at least in part on whether or not the first fault exists, whether or not the second fault exists, whether or not the third fault exists, whether or not the fourth fault exists, and whether or not the fifth fault exists, at least the one or more control signals related to the limited power source protection for the power supply charger.

As an example, the first threshold voltage, the third threshold voltage, the fifth threshold voltage, the seventh threshold voltage, and the first threshold frequency each correspond to a first threshold current related to the output current of the power supply charger; and the second threshold voltage, the fourth threshold voltage, the sixth threshold voltage, the eighth threshold voltage, and the second threshold frequency each correspond to a second threshold current related to the output current of the power supply charger. For example, the first threshold current is larger than the second threshold current. As an example, the one or more control signals related to the limited power source protection for the power supply charger include a control signal associated with a first gate of the first transistor; and the logic controller is further configured to output the control signal to the first gate of the first transistor. For example, the logic controller is further configured to output the control signal to the first gate of the first transistor through at least a second resistor. As an example, the one or more control signals related to the limited power source protection for the power supply charger include a control signal associated with a second gate of the second transistor; and the logic controller is further configured to output the control signal to the second gate of the second transistor. For example, the one or more control signals related to the limited power source protection for the power supply charger include a control signal associated with an optocoupler emitter; and the logic controller is further configured to output the control signal to the optocoupler emitter.

According to some embodiments, a power supply charger includes: a first transistor configured to provide an output current of the power supply charger and an output voltage of the power supply charger; a first resistor configured to receive a resistor current that is equal to the output current in magnitude; and a fast charging protocol controller coupled to the first transistor and the first resistor; wherein the fast charging protocol controller includes: a first transistor voltage-drop detector configured to detect a first transistor voltage drop from a first drain of the first transistor to a first source of the first transistor; a resistor voltage-drop detector configured to detect a resistor voltage drop from a first resistor terminal of the first resistor to a second resistor terminal of the first resistor; and a logic controller coupled to the first transistor voltage-drop detector and the resistor voltage-drop detector; wherein the first transistor voltage-drop detector is further configured to: compare the detected first transistor voltage drop with a first threshold voltage to generate a first comparison signal; and compare the detected first transistor voltage drop with a second threshold voltage to generate a second comparison signal; wherein the resistor voltage-drop detector is further configured to: compare the detected resistor voltage drop with a third threshold voltage to generate a third comparison signal; and compare the detected resistor voltage drop with a fourth threshold voltage to generate a fourth comparison signal; the logic controller is further configured to: receive the first comparison signal and the second comparison signal from the first transistor voltage-drop detector; receive the third comparison signal and the fourth comparison signal from the resistor voltage-drop detector; determine, based at least in part on the first comparison signal, the second comparison signal, the third comparison signal and the fourth comparison signal, whether or not a first fault related to the first transistor exists and whether or not a second fault related to the first resistor exists; and output, based at least in part on whether or not the first fault exists and whether or not the second fault exists, at least one or more control signals related to a limited power source protection for the power supply charger. For example, the power supply charger is implemented according to at least FIG. 2, FIG. 3, FIG. 4, and/or FIG. 5.

As an example, the first threshold voltage is larger than the second threshold voltage; and the third threshold voltage is larger than the fourth threshold voltage. For example, the power supply charger further includes: a second transistor connected to a secondary winding of the power supply charger and coupled to the fast charging protocol controller; wherein the fast charging protocol controller further includes: a second transistor voltage-drop detector configured to detect a second transistor voltage drop from a second drain of the second transistor to a second source of the second transistor; wherein the second transistor voltage-drop detector is further configured to: compare the detected second transistor voltage drop with a fifth threshold voltage to generate a fifth comparison signal; and compare the detected second transistor voltage drop with a sixth threshold voltage to generate a sixth comparison signal. As an example, the fifth threshold voltage is larger than the sixth threshold voltage. For example, the logic controller is further configured to: receive the fifth comparison signal and the sixth comparison signal from the second transistor voltage-drop detector; determine, based at least in part on the first comparison signal, the second comparison signal, the third comparison signal, the fourth comparison signal, the fifth comparison signal and the sixth comparison signal, whether or not the first fault related to the first transistor exists, whether or not the second fault related to the first resistor exists, and whether or not a third fault related to the second transistor exists; and output, based at least in part on whether or not the first fault exists, whether or not the second fault exists, and whether or not the third fault exists, at least the one or more control signals related to the limited power source protection for the power supply charger.

As an example, the fast charging protocol controller further includes: a voltage detector configured to detect an input voltage related to a load connected to the power supply charger; wherein the voltage detector is further configured to: compare the detected input voltage with a seventh threshold voltage to generate a seventh comparison signal; and compare the detected input voltage with an eighth threshold voltage to generate an eighth comparison signal. For example, the seventh threshold voltage is larger than the eighth threshold voltage. As an example, the logic controller is further configured to; receive the seventh comparison signal and the eighth comparison signal from the voltage detector; determine, based at least in part on the first comparison signal, the second comparison signal, the third comparison signal, the fourth comparison signal, the fifth comparison signal, the sixth comparison signal, the seventh comparison signal and the eighth comparison signal, whether or not the first fault related to the first transistor exists, whether or not the second fault related to the first resistor exists, whether or not the third fault related to the second transistor exists, and whether or not a fourth fault related to the input voltage exists; and output, based at least in part on whether or not the first fault exists, whether or not the second fault exists, whether or not the third fault exists, and whether or not the fourth fault exists, at least the one or more control signals related to the limited power source protection for the power supply charger.

For example, the fast charging protocol controller further includes: a frequency detector configured to detect a switching frequency related to the power supply charger; wherein the frequency detector is further configured to: compare the detected switching frequency with a first threshold frequency to generate a ninth comparison signal; and compare the detected switching frequency with a second threshold frequency to generate a tenth comparison signal. As an example, the first threshold frequency is larger than the second threshold frequency. For example, the logic controller is further configured to: receive the ninth comparison signal and the tenth comparison signal from the frequency detector; determine, based at least in part on the first comparison signal, the second comparison signal, the third comparison signal, the fourth comparison signal, the fifth comparison signal, the sixth comparison signal, the seventh comparison signal, the eighth comparison signal, the ninth comparison signal and the tenth comparison signal, whether or not the first fault related to the first transistor exists, whether or not the second fault related to the first resistor exists, whether or not the third fault related to the second transistor exists, whether or not the fourth fault related to the input voltage exists, and whether or not a fifth fault related to the switching frequency exists; and output, based at least in part on whether or not the first fault exists, whether or not the second fault exists, whether or not the third fault exists, whether or not the fourth fault exists, and whether or not the fifth fault exists, at least the one or more control signals related to the limited power source protection for the power supply charger.

As an example, the first threshold voltage, the third threshold voltage, the fifth threshold voltage, the seventh threshold voltage, and the first threshold frequency each correspond to a first threshold current related to the output current of the power supply charger; and the second threshold voltage, the fourth threshold voltage, the sixth threshold voltage, the eighth threshold voltage, and the second threshold frequency each correspond to a second threshold current related to the output current of the power supply charger. For example, the first threshold current is larger than the second threshold current. As an example, the one or more control signals related to the limited power source protection for the power supply charger include a control signal associated with a first gate of the first transistor; and the fast charging protocol controller is configured to output the control signal to the first gate of the first transistor. For example, the fast charging protocol controller is further configured to output the control signal to the first gate of the first transistor through at least a second resistor. As an example, the one or more control signals related to the limited power source protection for the power supply charger include a control signal associated with a second gate of the second transistor; and the fast charging protocol controller is configured to output the control signal to the second gate of the second transistor. For example, the one or more control signals related to the limited power source protection for the power supply charger include a control signal associated with an optocoupler emitter; and the fast charging protocol controller is configured to output the control signal to the optocoupler emitter.

According to certain embodiments, a method for a fast charging protocol controller of a power supply charger includes: detecting a first transistor voltage drop from a first drain of a first transistor to a first source of the first transistor to generate a first comparison signal and a second comparison signal, the first transistor being configured to provide an output current of the power supply charger and an output voltage of the power supply charger; detecting a resistor voltage drop from a first resistor terminal of a first resistor to a second resistor terminal of the first resistor to generate a third comparison signal and a fourth comparison signal, the first resistor being configured to receive a resistor current that is equal to the output current in magnitude; and outputting at least one or more control signals related to a limited power source protection for the power supply charger based at least in part on the first comparison signal, the second comparison signal, the third comparison signal, and the fourth comparison signal; wherein the detecting a first transistor voltage drop from a first drain of a first transistor to a first source of the first transistor to generate a first comparison signal and a second comparison signal includes: comparing the detected first transistor voltage drop with a first threshold voltage to generate the first comparison signal; and comparing the detected first transistor voltage drop with a second threshold voltage to generate the second comparison signal; wherein the detecting a resistor voltage drop from a first resistor terminal of a first resistor to a second resistor terminal of the first resistor to generate a third comparison signal and a fourth comparison signal includes: comparing the detected resistor voltage drop with a third threshold voltage to generate the third comparison signal; and comparing the detected resistor voltage drop with a fourth threshold voltage to generate the fourth comparison signal; wherein the outputting at least one or more control signals related to a limited power source protection for the power supply charger includes: receiving the first comparison signal, the second comparison signal, the third comparison signal and the fourth comparison signal; determining, based at least in part on the first comparison signal, the second comparison signal, the third comparison signal and the fourth comparison signal, whether or not a first fault related to the first transistor exists and whether or not a second fault related to the first resistor exists; and outputting, based at least in part on whether or not the first fault exists and whether or not the second fault exists, at least the one or more control signals related to the limited power source protection for the power supply charger. For example, the method is implemented according to at least FIG. 2, FIG. 3, FIG. 4, and/or FIG. 5.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, various embodiments and/or examples of the present disclosure can be combined.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A fast charging protocol controller for a power supply charger, the fast charging protocol controller comprising:
a first transistor voltage-drop detector configured to detect a first transistor voltage drop from a first drain of a first transistor to a first source of the first transistor, the first transistor being configured to provide an output current of the power supply charger and an output voltage of the power supply charger;
a resistor voltage-drop detector configured to detect a resistor voltage drop from a first resistor terminal of a first resistor to a second resistor terminal of the first resistor, the first resistor being configured to receive a resistor current that is equal to the output current in magnitude; and
a logic controller coupled to the first transistor voltage-drop detector and the resistor voltage-drop detector;
wherein the first transistor voltage-drop detector is further configured to:
compare the detected first transistor voltage drop with a first threshold voltage to generate a first comparison signal; and
compare the detected first transistor voltage drop with a second threshold voltage to generate a second comparison signal;
wherein the resistor voltage-drop detector is further configured to:
compare the detected resistor voltage drop with a third threshold voltage to generate a third comparison signal; and
compare the detected resistor voltage drop with a fourth threshold voltage to generate a fourth comparison signal;
the logic controller is further configured to:
receive the first comparison signal and the second comparison signal from the first transistor voltage-drop detector;
receive the third comparison signal and the fourth comparison signal from the resistor voltage-drop detector;
determine, based at least in part on the first comparison signal, the second comparison signal, the third comparison signal and the fourth comparison signal, whether or not a first fault related to the first transistor exists and whether or not a second fault related to the first resistor exists; and
output, based at least in part on whether or not the first fault exists and whether or not the second fault exists, at least one or more control signals related to a limited power source protection for the power supply charger.

2. The fast charging protocol controller of claim 1 wherein:
the first threshold voltage is larger than the second threshold voltage; and
the third threshold voltage is larger than the fourth threshold voltage.

3. The fast charging protocol controller of claim 1, and further comprising:
a second transistor voltage-drop detector configured to detect a second transistor voltage drop from a second drain of a second transistor to a second source of the second transistor, the second transistor being connected to a secondary winding of the power supply charger;
wherein the second transistor voltage-drop detector is further configured to:
compare the detected second transistor voltage drop with a fifth threshold voltage to generate a fifth comparison signal; and
compare the detected second transistor voltage drop with a sixth threshold voltage to generate a sixth comparison signal.

4. The fast charging protocol controller of claim 3 wherein the fifth threshold voltage is larger than the sixth threshold voltage.

5. The fast charging protocol controller of claim 3 wherein the logic controller is further configured to:
receive the fifth comparison signal and the sixth comparison signal from the second transistor voltage-drop detector;
determine, based at least in part on the first comparison signal, the second comparison signal, the third comparison signal, the fourth comparison signal, the fifth comparison signal and the sixth comparison signal, whether or not the first fault related to the first transistor exists, whether or not the second fault related to the first resistor exists, and whether or not a third fault related to the second transistor exists; and
output, based at least in part on whether or not the first fault exists, whether or not the second fault exists, and whether or not the third fault exists, at least the one or more control signals related to the limited power source protection for the power supply charger.

6. The fast charging protocol controller of claim 5, and further comprising:
a voltage detector configured to detect an input voltage related to a load connected to the power supply charger;
wherein the voltage detector is further configured to:
compare the detected input voltage with a seventh threshold voltage to generate a seventh comparison signal; and
compare the detected input voltage with an eighth threshold voltage to generate an eighth comparison signal.

7. The fast charging protocol controller of claim 6 wherein the seventh threshold voltage is larger than the eighth threshold voltage.

8. The fast charging protocol controller of claim 6 wherein the logic controller is further configured to:
receive the seventh comparison signal and the eighth comparison signal from the voltage detector;
determine, based at least in part on the first comparison signal, the second comparison signal, the third comparison signal, the fourth comparison signal, the fifth comparison signal, the sixth comparison signal, the seventh comparison signal and the eighth comparison signal, whether or not the first fault related to the first transistor exists, whether or not the second fault related to the first resistor exists, whether or not the third fault related to the second transistor exists, and whether or not a fourth fault related to the input voltage exists; and
output, based at least in part on whether or not the first fault exists, whether or not the second fault exists, whether or not the third fault exists, and whether or not the fourth fault exists, at least the one or more control signals related to the limited power source protection for the power supply charger.

9. The fast charging protocol controller of claim 8, and further comprising:
a frequency detector configured to detect a switching frequency related to the power supply charger;
wherein the frequency detector is further configured to:
compare the detected switching frequency with a first threshold frequency to generate a ninth comparison signal; and
compare the detected switching frequency with a second threshold frequency to generate a tenth comparison signal.

10. The fast charging protocol controller of claim 9 wherein the first threshold frequency is larger than the second threshold frequency.

11. The fast charging protocol controller of claim 9 wherein the logic controller is further configured to:
receive the ninth comparison signal and the tenth comparison signal from the frequency detector;
determine, based at least in part on the first comparison signal, the second comparison signal, the third comparison signal, the fourth comparison signal, the fifth comparison signal, the sixth comparison signal, the seventh comparison signal, the eighth comparison signal, the ninth comparison signal and the tenth comparison signal, whether or not the first fault related to the first transistor exists, whether or not the second fault related to the first resistor exists, whether or not the third fault related to the second transistor exists, whether or not the fourth fault related to the input voltage exists, and whether or not a fifth fault related to the switching frequency exists; and
output, based at least in part on whether or not the first fault exists, whether or not the second fault exists, whether or not the third fault exists, whether or not the fourth fault exists, and whether or not the fifth fault exists, at least the one or more control signals related to the limited power source protection for the power supply charger.

12. The fast charging protocol controller of claim 11 wherein:
the first threshold voltage, the third threshold voltage, the fifth threshold voltage, the seventh threshold voltage, and the first threshold frequency each correspond to a first threshold current related to the output current of the power supply charger; and
the second threshold voltage, the fourth threshold voltage, the sixth threshold voltage, the eighth threshold voltage, and the second threshold frequency each correspond to a second threshold current related to the output current of the power supply charger.

13. The fast charging protocol controller of claim 12 wherein the first threshold current is larger than the second threshold current.

14. The fast charging protocol controller of claim 11 wherein:
the one or more control signals related to the limited power source protection for the power supply charger include a control signal associated with a first gate of the first transistor; and
the logic controller is further configured to output the control signal to the first gate of the first transistor.

15. The fast charging protocol controller of claim 14 wherein the logic controller is further configured to output the control signal to the first gate of the first transistor through at least a second resistor.

16. The fast charging protocol controller of claim 11 wherein:
the one or more control signals related to the limited power source protection for the power supply charger include a control signal associated with a second gate of the second transistor; and
the logic controller is further configured to output the control signal to the second gate of the second transistor.

17. The fast charging protocol controller of claim 11 wherein:
the one or more control signals related to the limited power source protection for the power supply charger include a control signal associated with an optocoupler emitter; and
the logic controller is further configured to output the control signal to the optocoupler emitter.

18. A power supply charger comprising:
a first transistor configured to provide an output current of the power supply charger and an output voltage of the power supply charger;
a first resistor configured to receive a resistor current that is equal to the output current in magnitude; and
a fast charging protocol controller coupled to the first transistor and the first resistor;
wherein the fast charging protocol controller includes:
a first transistor voltage-drop detector configured to detect a first transistor voltage drop from a first drain of the first transistor to a first source of the first transistor;
a resistor voltage-drop detector configured to detect a resistor voltage drop from a first resistor terminal of the first resistor to a second resistor terminal of the first resistor; and
a logic controller coupled to the first transistor voltage-drop detector and the resistor voltage-drop detector;
wherein the first transistor voltage-drop detector is further configured to:
compare the detected first transistor voltage drop with a first threshold voltage to generate a first comparison signal; and
compare the detected first transistor voltage drop with a second threshold voltage to generate a second comparison signal;
wherein the resistor voltage-drop detector is further configured to:
compare the detected resistor voltage drop with a third threshold voltage to generate a third comparison signal; and
compare the detected resistor voltage drop with a fourth threshold voltage to generate a fourth comparison signal;
the logic controller is further configured to:
receive the first comparison signal and the second comparison signal from the first transistor voltage-drop detector;
receive the third comparison signal and the fourth comparison signal from the resistor voltage-drop detector;
determine, based at least in part on the first comparison signal, the second comparison signal, the third comparison signal and the fourth comparison signal, whether or not a first fault related to the first transistor exists and whether or not a second fault related to the first resistor exists; and
output, based at least in part on whether or not the first fault exists and whether or not the second fault exists, at least one or more control signals related to a limited power source protection for the power supply charger.

19. The power supply charger of claim 18 wherein:
the first threshold voltage is larger than the second threshold voltage; and
the third threshold voltage is larger than the fourth threshold voltage.

20. The power supply charger of claim 18, and further comprising:
a second transistor connected to a secondary winding of the power supply charger and coupled to the fast charging protocol controller;
wherein the fast charging protocol controller further includes:
a second transistor voltage-drop detector configured to detect a second transistor voltage drop from a second drain of the second transistor to a second source of the second transistor;
wherein the second transistor voltage-drop detector is further configured to:
compare the detected second transistor voltage drop with a fifth threshold voltage to generate a fifth comparison signal; and
compare the detected second transistor voltage drop with a sixth threshold voltage to generate a sixth comparison signal.

21. The power supply charger of claim 20 wherein the fifth threshold voltage is larger than the sixth threshold voltage.

22. The power supply charger of claim 20 wherein the logic controller is further configured to:
receive the fifth comparison signal and the sixth comparison signal from the second transistor voltage-drop detector;
determine, based at least in part on the first comparison signal, the second comparison signal, the third comparison signal, the fourth comparison signal, the fifth comparison signal and the sixth comparison signal, whether or not the first fault related to the first transistor exists, whether or not the second fault related to the first resistor exists, and whether or not a third fault related to the second transistor exists; and
output, based at least in part on whether or not the first fault exists, whether or not the second fault exists, and whether or not the third fault exists, at least the one or more control signals related to the limited power source protection for the power supply charger.

23. The power supply charger of claim 22 wherein the fast charging protocol controller further includes:
a voltage detector configured to detect an input voltage related to a load connected to the power supply charger;
wherein the voltage detector is further configured to:
compare the detected input voltage with a seventh threshold voltage to generate a seventh comparison signal; and
compare the detected input voltage with an eighth threshold voltage to generate an eighth comparison signal.

24. The power supply charger of claim 23 wherein the seventh threshold voltage is larger than the eighth threshold voltage.

25. The power supply charger of claim 23 wherein the logic controller is further configured to:
receive the seventh comparison signal and the eighth comparison signal from the voltage detector;
determine, based at least in part on the first comparison signal, the second comparison signal, the third comparison signal, the fourth comparison signal, the fifth comparison signal, the sixth comparison signal, the seventh comparison signal and the eighth comparison signal, whether or not the first fault related to the first transistor exists, whether or not the second fault related to the first resistor exists, whether or not the third fault related to the second transistor exists, and whether or not a fourth fault related to the input voltage exists; and
output, based at least in part on whether or not the first fault exists, whether or not the second fault exists, whether or not the third fault exists, and whether or not the fourth fault exists, at least the one or more control signals related to the limited power source protection for the power supply charger.

26. The power supply charger of claim 25 wherein the fast charging protocol controller further includes:
a frequency detector configured to detect a switching frequency related to the power supply charger;
wherein the frequency detector is further configured to:
compare the detected switching frequency with a first threshold frequency to generate a ninth comparison signal; and
compare the detected switching frequency with a second threshold frequency to generate a tenth comparison signal.

27. The power supply charger of claim 26 wherein the first threshold frequency is larger than the second threshold frequency.

28. The power supply charger of claim 26 wherein the logic controller is further configured to:
receive the ninth comparison signal and the tenth comparison signal from the frequency detector;
determine, based at least in part on the first comparison signal, the second comparison signal, the third comparison signal, the fourth comparison signal, the fifth comparison signal, the sixth comparison signal, the seventh comparison signal, the eighth comparison signal, the ninth comparison signal and the tenth comparison signal, whether or not the first fault related to the first transistor exists, whether or not the second fault related to the first resistor exists, whether or not the third fault related to the second transistor exists, whether or not the fourth fault related to the input voltage exists, and whether or not a fifth fault related to the switching frequency exists; and
output, based at least in part on whether or not the first fault exists, whether or not the second fault exists, whether or not the third fault exists, whether or not the fourth fault exists, and whether or not the fifth fault exists, at least the one or more control signals related to the limited power source protection for the power supply charger.

29. The power supply charger of claim 28 wherein:
the first threshold voltage, the third threshold voltage, the fifth threshold voltage, the seventh threshold voltage, and the first threshold frequency each correspond to a first threshold current related to the output current of the power supply charger; and
the second threshold voltage, the fourth threshold voltage, the sixth threshold voltage, the eighth threshold voltage, and the second threshold frequency each correspond to a second threshold current related to the output current of the power supply charger.

30. The power supply charger of claim 29 wherein the first threshold current is larger than the second threshold current.

31. The power supply charger of claim 28 wherein:
the one or more control signals related to the limited power source protection for the power supply charger include a control signal associated with a first gate of the first transistor; and
the fast charging protocol controller is configured to output the control signal to the first gate of the first transistor.

32. The power supply charger of claim 31 wherein the fast charging protocol controller is further configured to output the control signal to the first gate of the first transistor through at least a second resistor.

33. The power supply charger of claim 28 wherein:
the one or more control signals related to the limited power source protection for the power supply charger include a control signal associated with a second gate of the second transistor; and
the fast charging protocol controller is configured to output the control signal to the second gate of the second transistor.

34. The power supply charger of claim 28 wherein:
the one or more control signals related to the limited power source protection for the power supply charger include a control signal associated with an optocoupler emitter; and
the fast charging protocol controller is configured to output the control signal to the optocoupler emitter.

35. A method for a fast charging protocol controller of a power supply charger, the method comprising:
detecting a first transistor voltage drop from a first drain of a first transistor to a first source of the first transistor to generate a first comparison signal and a second comparison signal, the first transistor being configured to provide an output current of the power supply charger and an output voltage of the power supply charger;
detecting a resistor voltage drop from a first resistor terminal of a first resistor to a second resistor terminal of the first resistor to generate a third comparison signal and a fourth comparison signal, the first resistor being configured to receive a resistor current that is equal to the output current in magnitude; and
outputting at least one or more control signals related to a limited power source protection for the power supply charger based at least in part on the first comparison signal, the second comparison signal, the third comparison signal, and the fourth comparison signal;
wherein the detecting a first transistor voltage drop from a first drain of a first transistor to a first source of the first transistor to generate a first comparison signal and a second comparison signal includes:
comparing the detected first transistor voltage drop with a first threshold voltage to generate the first comparison signal; and
comparing the detected first transistor voltage drop with a second threshold voltage to generate the second comparison signal;
wherein the detecting a resistor voltage drop from a first resistor terminal of a first resistor to a second resistor terminal of the first resistor to generate a third comparison signal and a fourth comparison signal includes:
comparing the detected resistor voltage drop with a third threshold voltage to generate the third comparison signal; and
comparing the detected resistor voltage drop with a fourth threshold voltage to generate the fourth comparison signal;
wherein the outputting at least one or more control signals related to a limited power source protection for the power supply charger includes:
receiving the first comparison signal, the second comparison signal, the third comparison signal and the fourth comparison signal;
determining, based at least in part on the first comparison signal, the second comparison signal, the third comparison signal and the fourth comparison signal, whether or not a first fault related to the first transistor exists and whether or not a second fault related to the first resistor exists; and
outputting, based at least in part on whether or not the first fault exists and whether or not the second fault exists, at least the one or more control signals related to the limited power source protection for the power supply charger.
